(19) United States
(12) Patent Application Publication
(10) Pub. No.: US 2026/0320691 A1
(43) Pub. Date: Oct. 15, 2026

(54) SYSTEMS AND METHODS FOR PROVIDING PERSONALIZED INVESTMENT ASSET TRADE RECOMMENDATIONS

(71) Applicant: Daniel ROSEN, Chestnut Hill, MA (US)

(72) Inventor: Daniel ROSEN, Chestnut Hill, MA (US)

(21) Appl. No.: 19/644,320

(22) Filed: Apr. 10, 2026

Related U.S. Application Data
(60) Provisional application No. 63/787,216, filed on Apr. 11, 2025.

(51) Int. Cl. G06Q 40/06

(52) U.S. Cl. CPC G06Q 40/062; G06Q 40/0631

(57) ABSTRACT

In an illustrative embodiment, systems and methods include capturing asset performance snapshots including price data of investment vehicles, capturing entity sentiment snapshots including sentiment data regarding investment vehicles, and, for each investment vehicle, analyzing the price data of a series of asset performance snapshots and the sentiment data of a series of entity sentiment snapshots of each investment vehicle to identify anomalous movement over time. Responsive to identifying anomalous movement in some investment vehicles, providing the price data and the sentiment data of those investment vehicles to an artificial neural network trained or fine-tuned in historic analysis of circumstances triggering anomalous behavior to obtain forecast trajectories in asset value, and identifying, using the forecast trajectories and an investor's portfolio, recommended transaction(s) including a human-readable analysis detailing reasoning behind each recommendation prepared by a foundational model.

### RELATED APPLICATIONS

This application is a utility filing of and claims priority to U.S. Provisional Patent Application Ser. No. 63/787,216, entitled “Systems and Methods for Providing Personalized Investment Asset Trade Recommendations,” and filed Apr. 11, 2025. The above identified application is hereby incorporated by reference in its entirety.

### BACKGROUND

Online trading platforms have made trading in investment assets, such as stocks, bonds, exchange-traded funds, and cryptocurrency, accessible to the average person. Much information exists to guide individuals in their investment decisions, including the guidance of investment strategists who publish timely recommendations via print and/or multimedia. However, the guidance can be conflicting, confusing, and take too long for the average person to digest. Meanwhile, many individuals wish to develop a better-performing investment portfolio without resorting to hiring an investment advisor, especially younger adults and others with limited funds to place into traded assets. The inventor recognized the need for real-time, personalized, and optimized investment decision support appropriate to the amateur individual investor.

### SUMMARY OF ILLUSTRATIVE EMBODIMENTS

In one aspect, the present disclosure relates to an artificial intelligence (AI)-driven investment asset trading recommender system integrating hybrid decision-making, personalized trading advice, market sentiment analysis, and self-optimizing investment strategies. The investment asset trading recommender system may combine technical, sentiment, and fundamental analysis with time-series forecasting and reinforcement learning to generate real-time trade recommendations. Adapting to user behavior, the system may adjust strategy based on risk tolerance, performance, and/or market conditions. An investment asset trade recommendation, for example, may be initiated based in part on detecting anomalous behavior in an investment vehicle, such as a significant movement in price over a period of time. The anomalous behavior may be recognized in part through applying machine learning and/or artificial intelligence to historic performance data. News, analyst ratings, financial data, and/or additional market behaviors (e.g., economic indicators) may be analyzed in view of the anomalous behavior to anticipate a future performance trend in the investment asset. The analysis, for example, may be performed by machine learning and/or artificial intelligence to forecast the timing and impact of a future change in value of the investment asset. The trade recommendation may include a size, a timing window, and/or a trade position (e.g., sell, buy, short, etc.). The recommendation may be customized based on an individual's personal investment portfolio, historic interactions with the system, and/or stated preferences. The system may craft the customized recommendation in part on diversifying, balancing, and/or filling in deficiencies of the user's present portfolio.

The foregoing general description of the illustrative embodiments and the following detailed description thereof provide mere examples of various aspects of the teachings of this disclosure and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. In the drawings:

FIG. 1 is a block diagram of an example investment asset trading recommender platform and architecture;

FIG. 2 is a flow diagram of an example process for monitoring investment vehicles for anomalous performance indicators and determining a future performance prediction based on the anomalous behavior;

FIG. 3 is a flow diagram of an example process for determining a customized transaction recommendation based on predicted performance of an investment vehicle;

FIG. 4A is a flow chart of an example method for providing users with customized transaction recommendations;

FIG. 4B is a flow chart of an example method for determining whether a transaction is advisable for a user in view of anomalous movement in an asset of interest to the user;

FIG. 5A through FIG. 5D illustrate a series of example user interface arrangements for presenting a transaction recommendation to a user;

FIG. 6 is a flow diagram of an example process for analyzing outcomes related to past predictions;

FIG. 7 is a flow diagram of an example process for analyzing member interactions with transaction recommendations;

FIG. 8A through FIG. 8C illustrate a series of example user interface arrangements for presenting a full analysis regarding an asset of interest and the reasoning for recommending a particular transaction; and

FIG. 9 is a flow chart of an example method for identifying a set of candidate investment vehicles for forming recommendations.

### DETAILED DESCRIPTION OF ILLUSTRATIVE EMBODIMENTS

The description set forth below in connection with the coordinating drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

As used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Further, the terms “approximately,” “about,” “proximate,” “minor variation,” and similar terms generally refer to ranges that include the identified value within some margin, such as, in some examples, 20%, 10%, or 5% in certain embodiments, as well as any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

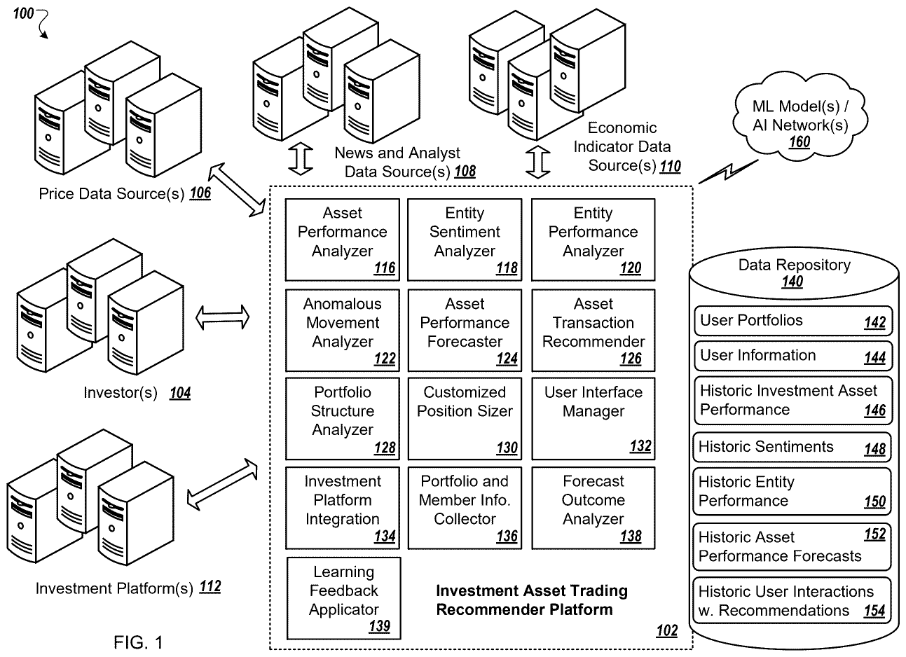

FIG. 1 is a block diagram of an example investment asset trading recommender platform 102 and architecture 100 for providing real-time, customized investment recommendations personalized to individual investors 104. In some embodiments, the investors 104 interact with the investment asset trading recommender platform to receive guidance in placing trades to develop an investment portfolio. For example, the investors may access the investment asset trading recommender platform 102 via a web browser, smart device application, or API connected to a separate software service, such as a trading platform service. In some embodiments, investment platforms 112 connect to the investment asset trading recommender platform 102, acting as a go-between for the investors 104 and enabling investor recommendations from the investment asset trading recommender platform 102. For example, an overlay to the browser experience and/or application of a given investment platform 112 may integrate the user's experience with the investment platform 112 and the investment asset trading recommender platform 102. The investors, for example, may apply recommendations received from the investment asset trading recommender platform 102 in placing trades with one or more investment platforms 112.

The investment asset trading recommender platform 102, as illustrated, includes the set of processing units 116, 118, 120, 122, 124, 126, 128, 130, 132, 134, 136, and 138 (e.g., software engines, routines, algorithms, or other portions of the investment asset trading recommender platform 102). Each processing unit 116, 118, 120, 122, 124, 126, 128, 130, 132, 134, 136, and/or 138 may be individually coded as instructions (e.g., software code) for executing on processing circuitry, such as one or more processors. Certain engines or operations performed by certain engines, in some embodiments, are configured as hardware logic (e.g., hardware-based operations) hard-coded or programmed into processing circuitry, such as, in some examples, a programmable logic chip or other programmable logic device, an application-specific integrated circuit (ASIC), or a customized processor device. Although shown as a certain set of processing units 116, 118, 120, 122, 124, 126, 128, 130, 132, 134, 136, and 138, in other embodiments, the investment asset trading recommender platform 102 may include or more fewer processing units. Additionally, in other embodiments, one or more processing units, or portions thereof, may be executed on a separate system, such as a cloud-based processing system or edge server.

In some implementations, the investment asset trading recommender platform 102 includes an asset performance analyzer 116 configured to analyze historic and recent performance of an investment asset. The asset performance analyzer 116, for example, may access one or more price data sources 106, such as, in some examples, the Finnhub. io stock application programming interface (API), the Morningstar stock API, the Xignite stock API, and/or the Bloomberg stock API. The asset performance analyzer 116 may store current price data to a historic investment asset performance data set 146 of a data repository 140. The asset performance analyzer 116 may analyze a daily or current (e.g., real-time or near real-time) stock price against price data points previously stored to the historic asset performance data 146 and/or obtained via one of the price data sources 106.

In some implementations, an entity sentiment analyzer 118 collects publications regarding entities behind investment assets (e.g., corporations, cryptocurrency payment networks, etc.) and analyzes the publications to derive current sentiment regarding the entities. Multiple entities may be recognized to exist under a single umbrella organization (e.g., stock ticker), in some circumstances involving distributed organizations (e.g., having multiple subsidiaries), and the sentiment analysis may take into consideration the subsidiary associations and potential impact of subsidiary news on the larger organization. The publications, in some examples, may be collected from one or more news sources and/or analyst data sources 108. The news sources and/or analyst data sources 108, in some illustrative examples, can include the Associated Press (AP) News, Bloomberg Finance News, Reuters, and/or the World News API. In some embodiments, the entity sentiment analyzer 118 instructs one or more artificial intelligence networks 160 to collect recent information regarding the entity through one or more Internet-accessible channels, such as, in some examples, entity-posted press releases (e.g., submitted via the entity's website and/or social media channels), industry news channels, and/or financial news channels.

The entity sentiment analyzer 118, in some implementations, analyzes the publications to determine current sentiment regarding an entity (or network of entities) behind an investment asset. The entity sentiment analyzer 118, in some examples, may consider the scope of the press (e.g., number/frequency of articles, breadth of sharing via social media, geographic breadth of distribution of the news, etc.), the direction of sentiment (e.g., positive news versus negative news), and/or the timing associated with the sentiment (e.g., acquisition in X days, product release in Y days, etc.).

The entity sentiment analyzer 118, in some embodiments, interacts with one or more machine learning models and/or artificial intelligence networks 160 in analyzing the publications. The entity sentiment analyzer 118, for example, may use natural language processing machine learning models 160 to parse meaning from the publications. In another example, the entity sentiment analyzer 118 may train, fine-tune, and/or prompt engineer a neural network to analyze the contents of the publications to derive sentiment. The network network may be trained or fine-tuned, for example, in part by using a set of truth data including articles and/or other publications identified as communicating a particular direction of sentiment (e.g., positive, negative) related to an investment vehicle and/or an organization represented by an investment vehicle. The entity sentiment analyzer 118, for example, may supply collected publications and/or curated news sources to one or more foundational models with one or more prompts configured to direct the foundational model(s) to derive direction of sentiment, scope (impact) of the news (e.g., within the corporate industry, geographical region, financial sector, etc.) and/or timing of the news topic (e.g., acquisition, product release, etc.). The entity sentiment analyzer 118, for example, may store sentiment data to the data repository as historic sentiment data 148.

In some implementations, an entity performance analyzer 120 collects economic data regarding one or more organizations of an entity behind an investment asset and analyzes the economic data to determine entity economic performance. The entity performance analyzer 120, for example, may gather economic indicator data (e.g., earnings reports, financial statements, financial analyst evaluations, etc.) regarding one or more organizations of an entity to determine a financial position of the entity behind an investment asset. The entity performance analyzer 120, for example, may gather information from one or more economic indicator data sources 110, such as, in some examples, Moody's and/or Bloomberg published reports. In another example, the entity performance analyzer 120 may gather economic information posted by an entity (e.g., to its website). In a further information, distilled earnings data may be accessed from various authorities, such as Nasdaq. The entity performance analyzer 120 may analyze, in some examples, corporate earnings, revenue, and/or debt. The entity performance analyzer may store economic data regarding each entity and/or organization thereof as historic entity performance data 150. The entity performance analyzer 120, in another example, may submit engineered prompts to one or more AI networks 160 to obtain an entity performance data set. The AI network(s) 160, for example, may be prompted to evaluate publications provided by the entity performance analyzer 120 and/or obtained from one or more curated sources identified by the entity performance analyzer 120 to extract a set of economic metrics. The economic metrics, in some examples, may include earnings per share (EPS), a mean of multiple historic EPS values, price-to-earnings (P/E) ratio, and/or a mean of multiple historic P/E ratios. The AI network(s) 160, for example, may be provided a taxonomy of economic indicators and/or metrics for identifying and extracting from publications and/or other curated sources.

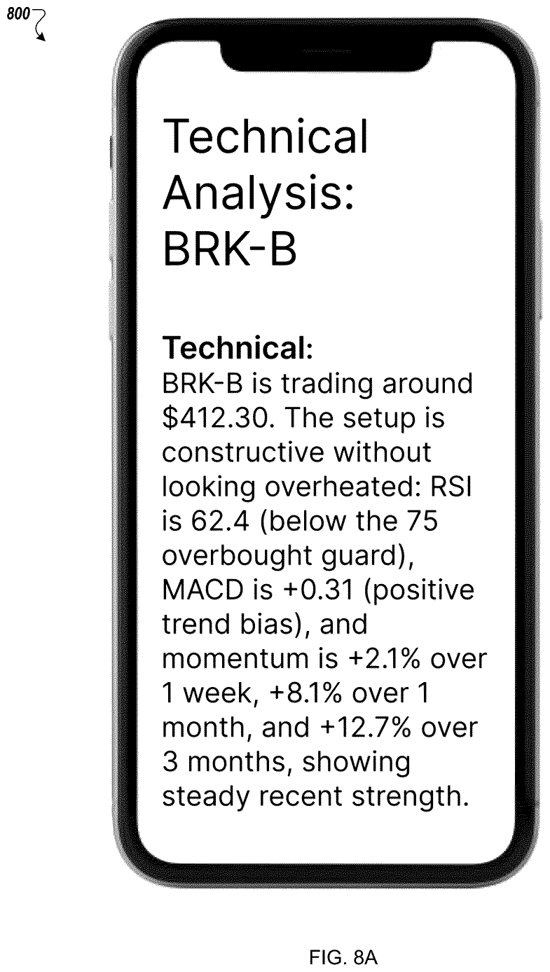

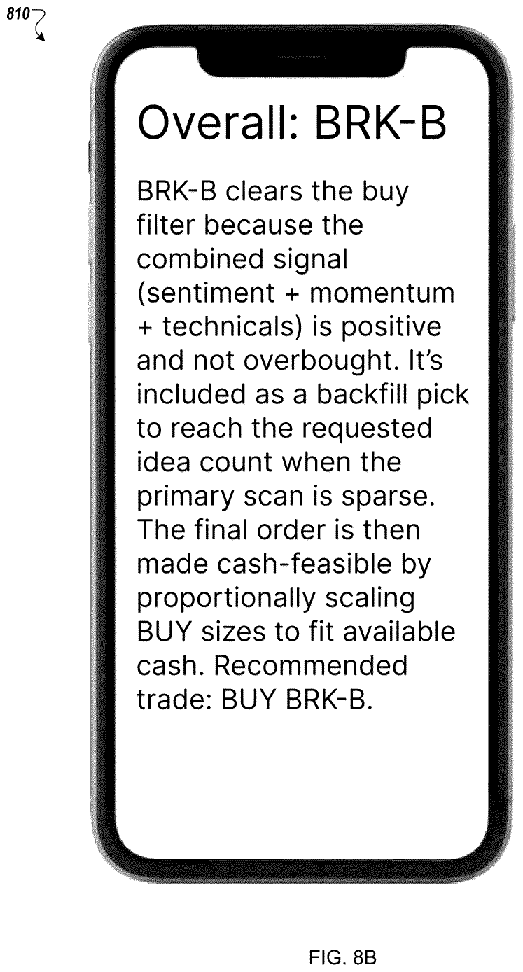

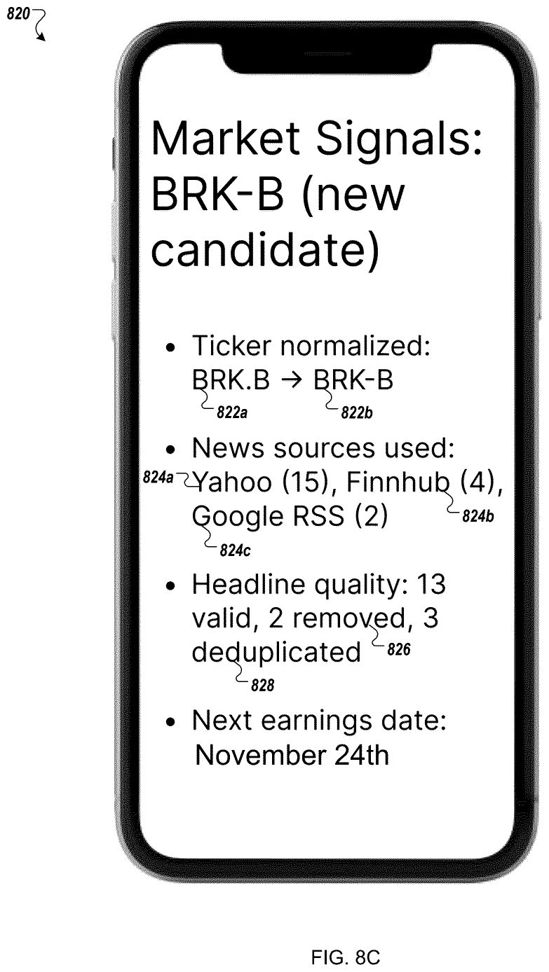

In some embodiments, the entity performance analyzer 120 collects economic data from the earnings reports source(s) 222 based on an anticipated release date (earnings date). For example, the entity performance analyzer 120 may be configured to automatically collect economic data related to each of a set of investment vehicles based on published earnings release dates associated with each of the set of investment vehicles. For example, as illustrated in an example user interface 820 of FIG. 8C, a next earnings date (“November 24^{th}”) is provided in relation to a subject investment vehicle (“BRK-B”).

In some implementations, an anomalous movement analyzer 122 evaluates most recent asset performance data, entity sentiment data, and/or entity performance data in view of historic asset performance data 146, historic sentiment data 148 and/or historic entity performance data 150 (e.g., stored to the data repository 140) to identify changes in data values that may be indicative of a significant impact in future asset performance, for example causing a significant increase in investment asset value or a significant decrease in investment asset value within a relatively short timeframe (e.g., within hours, 1 day, days, 1 week, or up to a handful of weeks). The anomalous movement analyzer 122, in some examples, may perform such analysis on a periodic basis (e.g., every 20 minutes, every hour, four times daily, at least daily, etc.), as new information is received (e.g., from the news and analyst data source(s) 108, from the economic indicator data source(s) 110), and/or upon request (e.g., by a user interested in a trade analysis performed by the investment asset trading recommender platform 102 related to a particular investment asset or set of investment assets). Earnings reports and economic data for organizations, for example, may be analyzed on a periodic basis, as released (e.g., quarterly, bi-annually, annually, etc.), while sentiment analysis may be performed at least daily and/or as new information is recognized. In illustration, a watch may be placed by the investment asset trading recommender platform 102 to collect new press releases related to a set of organizations corresponding to a set of investment assets, such as the investment assets in the S&P 500 or all Nasdaq listed stocks. In another illustration, the investment asset trading recommender platform 102 may collect and analyze publications related to any investment assets in new user portfolio data 142 that lack historic data collected by the platform 102 (e.g., in the data repository 140).

The anomalous movement analyzer 122, in some implementations, analyzes historic data trends to recognize behavior outside a typical window of behavior. The typical window of behavior, in some examples, may be in comparison to the investment asset itself, in comparison to a set of peers, in comparison to the industry, and/or in comparison to the asset class. For example, the anomalous movement analyzer 122 may perform sequence classification analysis on one or more sets of data to identify behavior anomalous within the recent series of events. Recency may be based in part on a type of data. Recency in the realm of economic performance of the entity, for example, may be analyzed in view of multiple quarters and/or years, while recency in the realm of stock price performance may be analyzed in view of weeks, days, or even a span as brief as four hours. The anomalous movement analyzer 122 may further apply one or more thresholds to the calculated movement to filter out movements likely to create a significant impact on investment value. In some embodiments, the anomalous movement analyzer 122 applies at least one machine learning model and/or AI network 160 to perform the sequence classification analysis. The machine learning model and/or AI network(s) 160, for example, may be trained or fine-tuned, for example, in part by using a set of truth data including historic investment vehicle performance data (e.g., stock prices, performance metrics, etc.) to recognize patterns indicative of movements (e.g., momentum) likely to significantly impact investment value. Significant impact, for example, may include a statistically relevant difference in value in comparison to a baseline, such as, in some examples, a stock index, an industry performance trend, and/or a trend over a prior window of time for the same investment vehicle (e.g., a localized change in momentum in view of a past week, two weeks, month, etc.).

In some embodiments, the anomalous movement analyzer 122 calculates one or more metrics representing anomalous behaviors over time. In a first example, an anomalous behavior over time may be calculated as a deviation from underlying market movements, such as a z-score capturing investment asset values across a set time period (e.g., one week, ten days, two weeks, twenty days, three weeks, etc.). In a second example, a number of spikes in trade volume over a set time period (e.g., at least X spikes over N days) may be flagged as anomalous behavior. In a third example, an increased volume of publications and/or strong sentiment demonstrated in publications over a time period (e.g., three days, one week, ten days, two weeks, etc.) may be indicative of anomalous movement.

If significant anomalous behavior is detected, in some implementations, an asset performance forecaster 124 determines a likely trajectory of asset value for the investment asset. The trajectory, for example, may include multiple estimated movements in values along an estimated timeframe. The asset performance forecaster 124 may calculate, in view of the anomalous behavior as well as the historic performance patterns, a new estimated performance pattern. The asset performance forecaster 124 may apply historic analysis of similar circumstances triggering anomalous behavior in investment assets not necessarily including the subject investment asset, such as peer assets, industry assets, and/or assets within a same asset class. The asset performance forecaster 124, for example, may anticipate future performance trajectory based in part on similar corporate events, similar price movements, and/or similar anomalous changes in corporate economic data. One or more machine learning models and/or AI networks 160 may be trained or fine-tuned in analyzing the anomalous movements of the subject asset in view of historic market behaviors. The machine learning model(s) and/or AI network(s) 160, for example, may be trained or fine-tuned, in part by using a set of truth data including historic investment vehicle performance trends or patterns (e.g., stock prices, performance metrics, etc.) to predict future trajectory based on current behavior (e.g., momentum over a window of time). Significant impact, for example, may include a statistically relevant difference in value in comparison to a baseline, such as, in some examples, a stock index, an industry performance trend, and/or a trend over a prior window of time for the same investment vehicle (e.g., a localized change in momentum in view of a past week, two weeks, month, etc.). The asset performance forecaster 124 may store the forecast trajectory in asset value to a historic asset performance forecasts data set 152 of the data repository 140.

In some implementations, an asset transaction recommender 126 prepares, in view of the forecast trajectory, a customized transaction recommendation for one or more investors 104. The customized transaction recommendation, in some examples, may include a trade type (e.g., buy, sell, short, etc.), a trade size (e.g., dollar value, number of shares, etc.), and/or a timeframe (e.g., within X hours, within Y days, etc.). Further, the customized transaction recommendation may include an investment asset analysis providing reasoning behind the recommendation. A portion of the reasoning may be prepared by the asset performance forecaster 124. The reasoning related to the investment asset and/or its underlying entity/organization(s), for example, may be applicable across all investors 104. Conversely, at least a portion of the reasoning may be specific to a particular investor 104 or set of investors 104 such as, in some examples, expanding to an asset class missing within the investor's portfolio, balancing holdings within the investor's portfolio, and/or matching a risk appetite of the particular investor. The analysis may explain reasoning related to one or more of the underlying data analyses (e.g., asset value, entity sentiment, and/or entity economics). The customized recommendation, for example, may be based at least in part on one or more deficiencies or “blind spots” within an individual investor's portfolio.

In some implementations, a portfolio structure analyzer 128 analyzes individual investment portfolios 142 associated with one or more investors 104 to identify opportunities for improving the asset holdings of the portfolio, for example to increase diversification and/or adjust to a risk target of the particular investor 104. A set of user information 144 regarding each of the investors 104 may include details regarding the investor's goals, risk tolerance, and/or budget for obtaining additional assets. Further, the set information 144, in some examples, may include an alert frequency setting identifying how frequently the user may wish to be alerted and/or a trade timing setting identifying a time sensitivity window for user consideration of recommendations. In illustration, certain investors 104 may wish to learn about “hot” tips that must be acted on within hours, while other investors may prefer less frequent and/or less time sensitive alerts. A portion of the user information 144, as described in greater detail below, may be intuited over time based on user interactions with the investment asset trading recommender platform 102. The portfolio structure analyzer 128, in some examples, may determine a current magnitude of position of the subject investment asset within the portfolio (e.g., not within the portfolio, X percentage of portfolio, X shares held, etc.), a current position of the subject investment asset's investment class within the portfolio (e.g.,, not within the portfolio, X percentage of portfolio, etc.), an available budget for adding or increasing investment in the subject investment asset, and/or a risk balance within the portfolio. A portion of the analysis performed by the portfolio structure analyzer 128 may be stored (e.g., within the user portfolios 142 and/or the user information 144) such that limited or no real-time analysis is required when determining trade recommendations responsive to the asset performance forecaster 124 identifying a likely significant shift in value of the subject investment asset.

In some implementations, a customized position sizer 130 obtains portfolio information prepared through analysis by the portfolio structure analyzer 128 and determines a magnitude of trade in the subject investment asset in view of the present composition of the investor's portfolio and/or the investor's present budget. The customized position sizer 130, for example, may calculate a position designed in view of the investor's current portfolio and investment goals. The customized position sizer 130, in addition to customizing a position recommendation, may generate reasoning behind the position recommendation. The reasoning, for example, may be provided to the asset transaction recommender in building a custom transaction recommendation for sharing with certain investors 104 that have portfolios, investment goals, and/or platform preferences aligning with the subject investment asset and its estimated future trajectory.

In some implementations, the asset transaction recommender 126 provides customized recommendation information and reasoning information to a user interface manager 132 for generating one or more alerts related to the recommendation. The alerts, in some examples, may be provided in one or more forms such as, in some examples, email, text and/or other messaging service, and/or mobile device application push notification. The format of the alert(s), in some embodiments, depend in part on the user information 144. For example, alert preferences may designate one or more desired alert formats. The user interface manager 132, in illustration, may prepare a graphical user interface push notification for presenting in a mobile device application, desktop computer application, and/or overlay to a third-party application (e.g., provided by one of the investment platforms 112).

In some implementations, the asset transaction recommender 126 provides the customized recommendation information and the reasoning information to an investment platform integration unit 134 to be issued (e.g., via an API) for consumption and presentation by a third-party service (e.g., provided by one of the investment platforms 112).

In some implementations, user interactions with a released alert are captured by a portfolio and member information collector 136. The user interactions, for example, may be stored as historic user interactions with recommendations data 154 (e.g., to the data repository 140). The portfolio and member information collector 136, for example, may log data regarding review of each alert (e.g., time, time delay from release, dwell time, device identifier used for review, etc.). Additionally, the portfolio and member information collector 136 may log data regarding any action taken by the user in response to an alert (e.g., trade submitted to one of the investment platforms 112, rejection of the recommendation, etc.

The user interface, in some embodiments, is integrated with at least one of the investment platforms 112, such that trade details regarding a trade (e.g., number of shares purchased, etc.) are provided automatically to the investment asset trading recommender platform 102. In this manner, the portfolio and member information collector 136 may update the user portfolio data 142 regarding any action taken via the investment platform(s) 112. Further, in some embodiments, the integration allows for the investment asset trading recommender platform 102 to cause placement of a trade at one of the investment platforms 112 (e.g., via an API integration).

In some embodiments, the user interface is configured to query the user regarding whether or not the recommendation was accepted (e.g., whether the user chose to place an order through one of the investment platforms 112). The user interface manager 132, for example, may present a brief survey to the user to gather details regarding any investment order placed in response to a recommendation alert.

The user, in some embodiments, is prompted to accept or reject each recommendation. For example, the user may be prompted with an option to flag each recommendation as useful or desirable, versus not useful or undesirable. The user interface manager 132 may further present a brief survey to determine the reasoning behind a user's acceptance or rejection of a recommendation. The reasoning, for example, may be used to update user information 144 with user preferences gleaned or intuited from user interactions with the investment asset trading recommender platform 102.

In some implementations, a forecast outcome analyzer 138 analyzes the historic asset performance forecasts 152 in view of actual movements in investment asset values to gauge accuracy of the recommendations presented by the investment asset trading recommender platform 102. The forecast outcome analyzer 138, for example, may supply the historic asset performance forecasts 152 to one of the ML models and/or AI networks 160 to provide feedback learning related to the recommendations generated by the asset performance forecaster 124. The feedback learning, for example, may be used to adjust future forecasts and/or the timings corresponding to certain forecasts.

In some implementations, a learning feedback applicator 139 analyzes the historic user interactions with recommendations data 154 to fine-tune the nature and/or timing of recommendations provided by the investment asset trading recommender platform. The learning feedback applicator 139, for example, may supply the historic user interactions with recommendations data 154 to one of the ML models and/or AI networks 160 to provide feedback related to the users'direct and/or indirect feedback related to recommendations provided by the investment asset trading recommender platform 102.

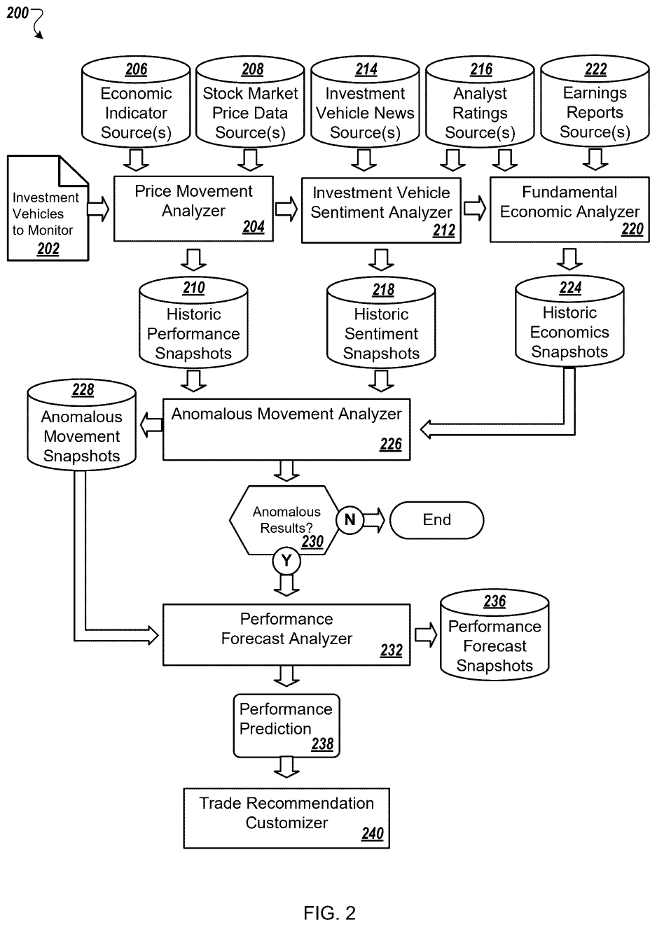

Turning to FIG. 2, a flow diagram illustrates an example process 200 for monitoring investment vehicles for anomalous performance indicators. The process 200, for example, may be performed by a portion of the processing units of the investment asset trading recommender platform 102 of FIG. 1.

In some implementations, the process 200 begins with receiving investment vehicle information 202 for a set of investment vehicles to monitor. The investment vehicles, for example, may include at least a portion of a stock index, the investment vehicles included in a portfolio of one of the users 104 of the investment asset trading recommender platform 102 of FIG. 1, and/or investment vehicles available for purchase via one of the investment platforms 112 of FIG. 1. The investment vehicles, for example, may be received at least in part through user text entry.

In some embodiments, the investment vehicles to monitor 202 are normalized to one or more standard formats used for querying information from one or more sources. The investment vehicles to monitor 202, for example, may be reformatted as New York Stock Exchange (NYSE) standard company symbols. The normalization, for example, may include preparing multiple versions of the identifiers of one or more of the investment vehicles, each identifier specific to a different information source of a set of information sources (e.g., economic indicator source(s) 206, stock market price data source(s) 208, investment vehicle news source(s) 214, analyst ratings source(s) 216, and/or earnings reports source(s) 222). For example, as illustrated in an example user interface 820 of FIG. 8C, an input stock ticker BRK.B 822a has been normalized to read BRK-B 822b.

In some implementations, a price movement analyzer 204 collects, from one or more economic indicator sources 206 and/or one or more stock market price data sources 208, present economic indicators and/or present stock market values for at least a portion of the investment vehicles to monitor 202. The price movement analyzer 204, in some implementations, applies a set of technical indicators and/or machine learning models to analyze trends or patterns in the fresh data set. For example, the stock movements within a shortened period of time (e.g., one hour, up to four hours, half a day, one day) may be analyzed to generate metrics indicative of trends, patterns, and/or general movements of prices within the data. The price movement analyzer 204, for example, may perform operations described in relation to the asset performance analyzer 116 (e.g., including gathering data from the price data sources 106). The price movement analyzer 204, for example, may capture a single data point (e.g., current price) per investment vehicle 202 or a series of data points (e.g., movements of prices in past ten minutes, past hour, past four hours, past day, since last triggered to review, etc.). The price movement analyzer 204 may store the economic indicators and/or stock market values to a historic performance snapshots data store 210 (e.g., the historic investment asset performance data 146 of the data repository 140 of FIG. 1). The historic performance snapshots 210 may include, in some examples, high values, low values, average values, and/or additional data points for each investment vehicle 202 on at least a daily monitoring basis.

In some implementations, an investment vehicle sentiment analyzer 212 collects, from one or more investment vehicle news sources 214 and/or one or more analyst ratings sources 216, present publications related to at least a portion of the investment vehicles to monitor 202. The investment vehicle sentiment analyzer 212 may perform queries against databases represented by the investment vehicle news sources 214 and/or analyst ratings sources 216 to identify news that may impact the investment vehicles. The queries, for example, may search for stock ticker, corporate name, subsidiary name(s), and/or corporate nickname(s) (e.g., “Coke” in addition to “Coca-Cola”) related to each of the set of investment vehicles 202. The queries, in illustration, may identify impactful news based upon tokens found in the title and/or a synopsis. The investment vehicle sentiment analyzer 212, for example, may perform operations described in relation to the entity sentiment analyzer 118 of FIG. 1 (e.g., including gathering data from the news and analyst data source(s) 108).

In some embodiments, the publications retrieved by the investment vehicle sentiment analyzer 212 are analyzed for sufficiency (e.g., publications containing more than a few sentences and/or more than a passing reference related to one of the investment vehicles to monitor 202). The investment vehicle sentiment analyzer 212, for example, may retrieve publications from one or more additional investment vehicle news sources 214 and/or analyst ratings sources 216 if an insufficient number or breadth of relevant publications have been retrieved upon an initial pass. Sufficiency of publications, in some examples, can include validity (e.g., valid readable file) and/or coverage (e.g., more than X number of sentences, more than a passing reference to the investment vehicle, etc.). A confidence score may be associated with the publication sufficiency. For example, the example user interface 820 of FIG. 8C indicates that two publications were removed 826 (e.g., due to lack of sufficient information, a problem with the file, etc.).

In some embodiments, the investment vehicle sentiment analyser 212 includes a deterministic fallback ladder of sources to query for publications regarding each investment vehicle. For example, as illustrated in the example user interface 820 of FIG. 8C, three different news sources 824a-c (e.g., Yahoo, Finnhub, and Google RSS) are identified. The example user interface 820 also indicates a number of publications retrieved from each (e.g., 15, 4, and 2).

The investment vehicle sentiment analyzer 212, in some embodiments, deduplicates retrieved publications to ensure a variety of information regarding each of the investment vehicles to monitor 202 is retrieved. For example, multiple news sources may replicate a same news bulletin or press release, such that, although each individual publication appears to contain sufficient amounts of information regarding a given investment vehicle, the same information is repeated throughout multiple publications. Deduplication may ensure sufficient breadth of information across retrieved publications to perform sentiment analysis. For example, as illustrated in the example user interface 820 of FIG. 8C, three downloaded publications were deduplicated (828).

In some implementations, the investment vehicle sentiment analyzer 212 analyzes each accessed publication for sentiment and relevance to the corresponding investment vehicle. The investment vehicle sentiment analyzer 212, for example, may apply natural language processing and/or machine learning models to filter publications, focusing on those appearing both relevant and to exhibit a significant sentiment (e.g., positive and/or negative news).

The investment vehicle sentiment analyzer 212, in some implementations, extracts one or more insights from at least a portion of the publications. The insights, for example, may include earnings predictions, timing of major events, and/or costs associated with a significant event (e.g., loss of manufacturing capacity due to a catastrophic event at a manufacturing facility). The investment vehicle sentiment analyzer 212 may store the sentiment and/or insights to a historic sentiment snapshots data store 218 (e.g., the historic sentiments data 148 of the data repository 140 of FIG. 1).

In some implementations, a fundamental economic analyzer 220 collects, from the analyst ratings source(s) 216 and/or one or more earnings reports sources 222, economic releases (e.g., quarterly earnings reports, annual earnings reports, corporate governance reports, etc.) related to at least a portion of the investment vehicles to monitor 202. The fundamental economic analyzer 220, for example, may perform operations described in relation to the entity performance analyzer 120 of FIG. 1 (e.g., including gathering data from the economic indicator data source(s) 110).

In some implementations, the fundamental economic analyzer 220 analyzes each accessed publication for economics indicator data such as, in some examples, macroeconomic data, profit and loss (P&L) statements, and/or balance sheet data. The fundamental economic analyzer 220, for example, may apply natural language processing, machine learning models, and/or foundational models to cull economic indicator data from the publications. Further, the fundamental economic analyzer 220 may evaluate the economic indicator data to determine financial ratios, market health indicators, and/or other metrics indicative of financial health of the corresponding investment asset vehicle. The fundamental economic analyzer 220, in another example, may evaluate the economic indicator data to identify economic trends within the information. The fundamental economic analyzer 220 may store the economic indicator data, financial health metrics, and/or economic trends data to a historic economics snapshots data store 224 (e.g., the historic entity performance data 150 of the data repository 140 of FIG. 1).

Although illustrated as a pipelined series of operations, the price movement analyzer 204, the investment vehicle sentiment analyzer 212, and/or the fundamental economic analyzer 220 may be executed concurrently and/or at different times. For example, the fundamental economic analyzer 220 may be executed on a periodic basis (e.g., monthly, quarterly, or whenever earnings data is anticipated from at least one of the investment vehicles 202), while the price movement analyzer 204 and the investment vehicle sentiment analyzer 212 may be executed at least daily. Further, in certain embodiments, one of the analyzers 204, 212, or 220 may be triggered to perform operations based on information derived by other ones of the analyzers 204, 212, 220, or an anomalous movement analyzer 226. For example, the investment vehicle sentiment analyzer 212 may recognize, in analyzing publications, an indication that new earnings data was recently released in relation to one of the investment vehicles 202, triggering performance by the fundamental economic analyzer 220 to retrieve and analyze the new earnings data.

In some implementations, an anomalous movement analyzer 226 analyzes newer data stored to the historic performance snapshots 210, the historic sentiment snapshots 218, and/or the historic economic snapshots 224 in view of historic data snapshots to identify anomalous trends in at least one of the investment vehicle performance, the sentiment, and/or the entity economics. The anomalous movement analyzer 226, for example may execute upon storage of new data to at least one of the snapshots data stores 210, 218, 224. The anomalous movement analyzer 226, for example, may perform operations described in relation to the anomalous movement analyzer 122 of FIG. 1.

The anomalous movement analyzer 226, in some implementations, analyzes historic investment vehicle values stored to the historic performance snapshots 210 to determine whether a most recent value or set of values represents an anomalous movement. The anomalous movement analyzer 226, for example, may apply one or more technical indicators, machine learning models, and/or foundational models to a window of historic data and/or a scrolling window of time of data points for a given investment vehicle to recognize anomalous movements in the data representative of a significant trend in an incongruous direction (e.g., increasingly positive movement, increasingly negative movement, shift from negative to positive, shift from positive to negative, etc.). The technical indicators, in some examples, may include one or more moving averages, the moving average convergence/divergence indicator, the relative strength index (RSI), the money flow index (MFI), and/or Bollinger Bands.

In some implementations, the anomalous movement analyzer 226 analyzes historic sentiment values and/or metrics stored to the historic sentiment snapshots 218 to determine whether a most recent data point or data set represents an anomalous movement. The anomalous movement analyzer 226, for example, may apply one or more machine learning models and/or foundational models to a window of historic data and/or a scrolling window of time of data points for one or more entities related to an investment vehicle to recognize anomalous movements in the data representative of a significant trend in an incongruous direction (e.g., increasingly positive movement, increasingly negative movement, shift from negative to positive, shift from positive to negative, etc.). Further, the anomalous movement analyzer 226 may apply one or more natural language processing models to text snapshots related to historic sentiment analysis to recognize trends in published discussions.

In some implementations, the anomalous movement analyzer 226 analyzes historic economic values and/or metrics stored to the historic economic snapshots 224 to determine whether recent economic data is indicative of an anomalous movement in comparison to historic economic data. The anomalous movement analyzer 226, for example, may apply one or more financial performance metrics and/or machine learning models to a window of historic data and/or a scrolling window of time of data points for one or more entities related to an investment vehicle to recognize anomalous movements in the data representative of a significant trend in an incongruous direction (e.g., increasingly stronger economics, increasingly weaker economics, shift from negative to positive economic trend, shift from positive to negative economic trend, etc.).

In some implementations, the anomalous movement analyzer 226 applies one or more long short-term memory (LSTM) recurrent neural networks (RNN) LSTM to recognize and propagate important data points or values throughout the time series of historic values. LSTM RNN learning models, for example, may be particularly beneficial in identifying key data values to understanding anomalous behavior in complex data sets, such as the historic sentiment snapshots 218 and/or the historic economics snapshots 224. The LSTM RNN learning models, for example, may derive, through analysis of historic information, one or more potential causes for anomalous movements so that when similar circumstances arise the anomalous movement result may be predicted with better accuracy. Further, the anomalous movement analyzer 226 may analyze more general market behaviors and/or industry behaviors to identify potential causes of the movements.

In some implementations, the anomalous movement analyzer 226 verifies the results of the one or more machine learning models and/or foundational models to ensure accurate and actionable results. The anomalous movement analyzer 226, for example, may exercise multiple models in parallel and confirm consistency across results. The anomalous movement analyzer 226, for example, may obtain results data from multiple different models (e.g., each designed for performing a different type of analysis such as analysis of the different historic data sets) to check the consistency of results across the different models. In illustration, the anomalous movement analyzer 226 may check whether a major historical event corresponded with the stock movement and, if so, may determine that this movement shouldn't be taken in as predictive data due to the unique nature of the circumstances. In another example, the anomalous movement analyzer 226 may apply a verification framework, such as the general and precise neural network certification via scalable convex hull approximations (PRIMA) verification framework to results generated by at least a portion of the applied models to confirm the performance of at least a portion of the applied models.

The anomalous movement analyzer 226, in some embodiments, analyzes trends and/or patterns in a geography, industry, asset class, and/or peer group of assets to use in comparison to any anomalous movements identified in relation to a given investment vehicle. The anomalous movement analyzer 226, for example, may take into consideration economic indicators that may impact the performance of a swath of investment assets including the investment asset. The anomalous movement analyzer 226, for example, may perform analysis to determine if previous economic events are similar to ones currently happening or expected to be happening soon. This analysis may then be applied to the recommendation process.

The anomalous movement analyzer 226, in some implementations, stores the results of analysis to an anomalous movement snapshots data store 228. The contents of the anomalous movement snapshots data store 228 may be used, in some examples, to generate a future performance prediction, to provide context behind a future performance prediction, and/or to provide feedback learning to one or more of the machine learning models and/or foundational models.

In some implementations, if the anomalous movement analyzer 226 determines that the recent data points represent anomalous movement (230), a performance forecast analyzer 232 translates the recent anomalous trends into a prediction of future performance of the investment vehicle 202. The performance forecast analyzer 232, for example, may analyze the anomalous movement snapshots 228 using one or more machine learning models and/or foundational models to translate the one or more anomalous movements identified by the anomalous movement analyzer 226 in relation to the given investment vehicle 202 (e.g., movement in performance, sentiment, and/or entity economics) into a predicted future outcome. The performance forecast analyzer 232 may perform operations described in relation to the asset performance forecaster 124 of FIG. 1.

The anomalous movement analyzer 226, for example, may calculate one or more performance metrics quantifying the anomalous trends. The performance metrics, for example, may each quantify performance during a time window (e.g., the past week, ten days, thirty days, one month, three months, etc.). In illustration, a multi-source momentum calculation may include a sentiment momentum value (e.g., weighted by a confidence in the sentiment analysis performed by the investment vehicle sentiment analyzer 212), an earnings momentum value (e.g., weighted by a confidence in the earnings analysis performed by the fundamental economic analyzer 220) and a price movement momentum value (e.g., weighted by a confidence in the price analysis performed by the price movement analyzer 204). A composite momentum metric combining the sentiment momentum value, the earnings momentum value, and the price movement momentum value, for example, may be applied to identifying candidate investment vehicles for recommendation. Further, momentum metrics may be derived representing multiple timespans such as, in some examples, a past three days, a past week, a past two weeks, a past month, and/or a past two or more months. The multiple momentum timespans, in a further example, may be used to derive a trend in momentum (e.g., acceleration or deceleration of momentum over time).

Identifying candidates for recommendation, in some embodiments, includes selecting candidates having momentum metrics meeting or exceeding a given threshold value. In some embodiments, identifying the set of candidates for recommendation includes ranking, by the anomalous movement analyzer 226, the momentum metric(s) for each of a set of investment vehicles and select a top N investment vehicles (e.g., top N overall, top N by industry, top N by risk category, top N by investment vehicle type, etc.).

In some embodiments, identifying one or more investment vehicles for recommendation includes applying a penalty weighting for investment vehicles designated as having been overbought (e.g., trading above a fair market value). Investment vehicles may be determined to be overbought, for example, by evaluating the RSI of the investment vehicle and/or Bollinger Bands metrics for the investment vehicle.

The performance forecast analyzer 232, in some implementations, generates performance prediction data 238 representing at least one future value of the investment vehicle 202 and at least one time (e.g., time of day, date, etc.) associated with the at least one future value. The performance prediction data 238, in illustration, may be represented by one or more formulas for anticipating future price over time, a begin time for value differentiation representing an investment opportunity, a maximum anticipated difference in investment value, and/or an end time for value differentiation representing an investment opportunity. In an illustrative example, the performance prediction data 238 may be stored as a table or set of records presenting a price and/or a movement in value with a corresponding timing, such as a date and a percentage increase/decrease in value of the investment asset. The performance prediction data 238, for example, may include the data stored as historic asset performance forecasts 152 in the data repository 140 of FIG. 1. The performance forecast analyzer 232 may store the prediction data 238 in a performance forecast snapshots data store 236. In some examples, the contents of the performance forecast snapshots data store 236 may be used to customize trade recommendations for one or more users and/or to provide feedback learning to one or more of the machine learning models and/or foundational models.

In some implementations, the performance prediction is provided to a trade recommendation customizer 240 for generating a customized trade recommendation appropriate to an investor's portfolio. The trade recommendation customizer 240, for example, may perform operations described in relation to the asset transaction recommender 126 of FIG. 1.

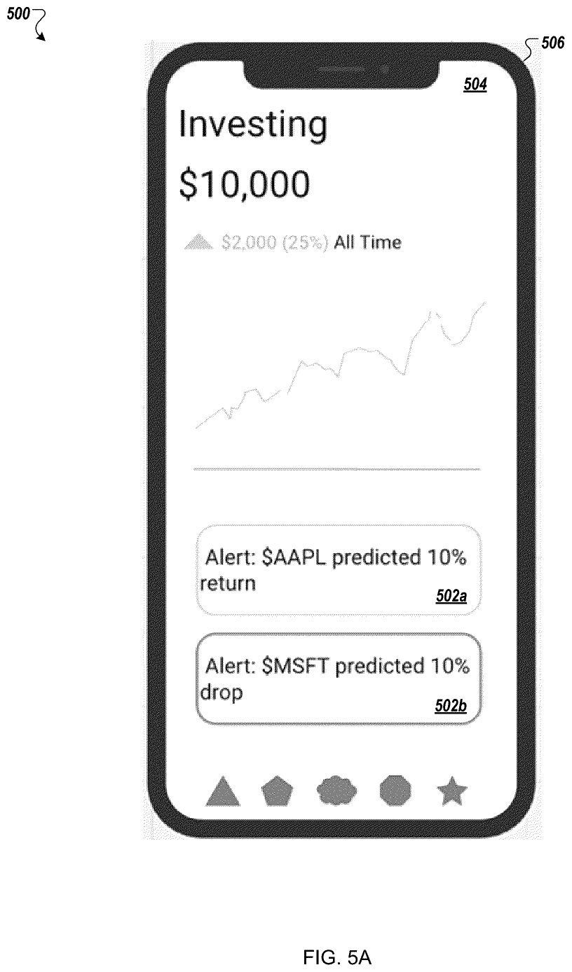

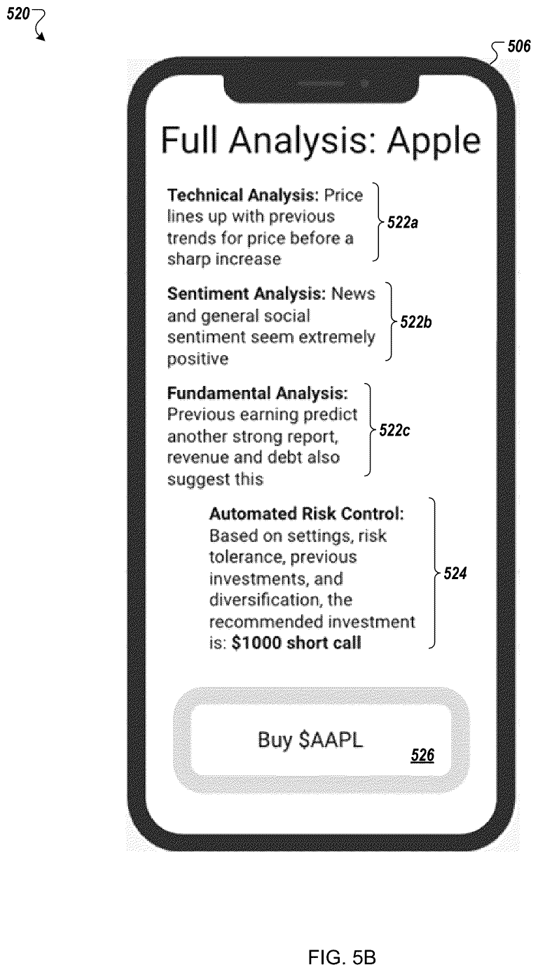

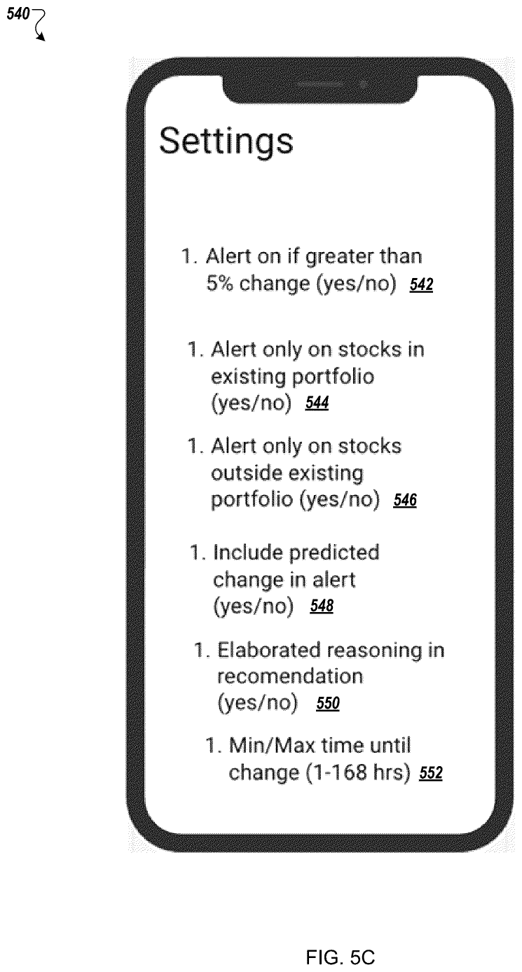

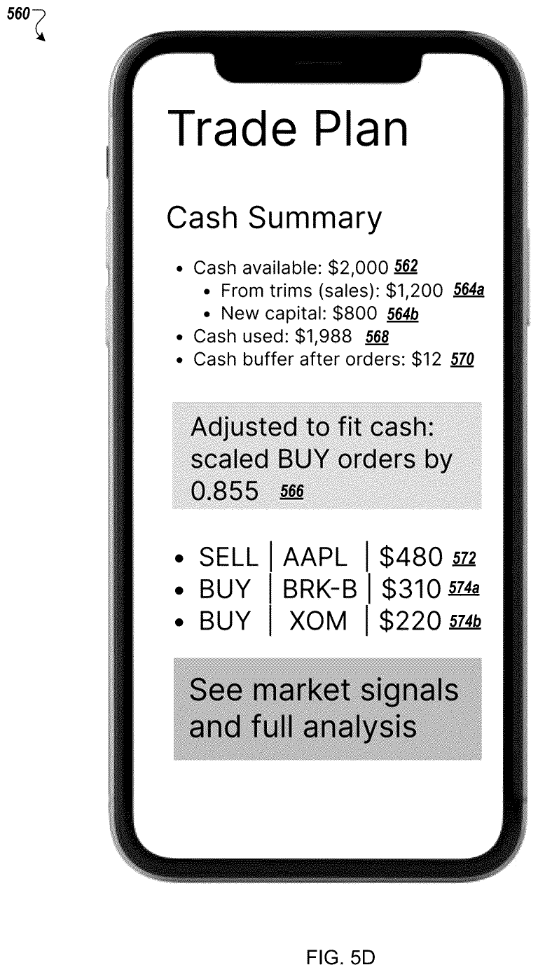

In some embodiments, the trade recommendation customizer 240 prepares trade recommendation reasoning for presentation to a member. The trade recommendation reasoning, for example, may be provided, in some examples, via the user interface manager 132 and/or the investment platform integration unit 134 of FIG. 1. The trade recommendation customizer 240, for example, may prepare information such as the full analysis information presented in an example user interface 520 of FIG. 5B. The analysis information, for example, may be prepared based on a template. In illustration, a foundational model may be prompted to prepare a synopsis of the analysis behind the recommendation using a standardized template. Further to the illustration, the template may include standard synopsis headers and/or be designed to incorporate data obtained from one of the sources 206, 208, 214, 216, or 222 and/or metrics calculated by one or more of the price movement analyzer 204, the investment vehicle sentiment analyzer 212, the fundamental economic analyzer 220, the anomalous movement analyzer 226, and/or the performance forecast analyzer 232.

The trade recommendation reasoning, in some embodiments, includes a technical analysis summarizing, in some examples, a price and/or price range of the financial vehicle (e.g., over a past day, at present time, etc.), one or more performance metrics (e.g., RSI, exponential moving average (EMA), simple moving average (SMA), moving average convergence divergence (MACD), momentum, etc.), and/or one or more comparison metrics (e.g., relative to a marketplace, industry, etc.).

Turning to FIG. 8A, an example user interface 800 is provided for presenting technical analysis summary information regarding a recommended investment asset. The example user interface 800, for example, may be prepared by the asset transaction recommender 126 of FIG. 1 and provided, for review by a user, by the user interface manager 132 of FIG. 1. As illustrated, the example user interface 800 contains a “technical analysis” of financial vehicle BRK-B. The synopsis recites a trading price, an RSI value (e.g., 62.4) in comparison to an RSI threshold (e.g., 75), a MACD (e.g., +0.31), and three momentum metrics (e.g., +2.1% over 1 week, +8.1% over 1 month, and +12.7% over 3 months). Further, the synopsis uses qualifying language such as, in some examples, “[t]he setup is constructive without looking overheated” and “showing steady recent strength.”

Returning to FIG. 2, in some embodiments, the trade recommendation customizer 240 prepares a reasoning synopsis covering main factors for reaching the decision to recommend the financial vehicle. The reasoning synopsis, for example, may highlight key factors in one or more of the price movement (e.g., analysis by the price movement analyzer 204), the investment vehicle sentiment (e.g., analysis by the investment vehicle sentiment analyzer 212), and/or fundamental economics (e.g., analysis by the fundamental economic analyzer 220). The reasoning synopsis, further, may explain one or more trends discovered by the anomalous movement analyzer 226. Additionally, the reasoning synopsis may present aspects of the performance prediction 238 developed by the performance forecast analyzer 232.

Turning to FIG. 8B, an example user interface 810 is provided for presenting reasoning synopsis information regarding the recommendation of an investment vehicle. The example user interface 810, for example, may be prepared by the asset transaction recommender 126 of FIG. 1 and provided, for review by a user, by the user interface manager 132 of FIG. 1. As illustrated in FIG. 8B, a reasoning synopsis regarding the investment vehicle BRK-B explains that a “combined signal (sentiment+momentum+technicals) is positive” and, further, the investment vehicle is “not overbought.” BRK-B is described as “a backfill pick to reach the requested idea count.” For example, a user may include a setting requesting N recommendations. Absent N recommended trades clearing member preferences, and/or member settings for a particular user (e.g., as stored in the user information 144 of FIG. 1), in some embodiments, the platform 102 of FIG. 1 may be configured to loosen gating (e.g., one or more thresholds or filters) to develop additional recommendations “when the primary scan is sparse” as noted in the user interfaced 810. Further, the reasoning synopsis notes that, for example based on less cash available in the user account than required to meet an initial recommended trade, the “final order is . . . made cash-feasible by proportionally scaling BUY sizes to fit available cash.” The reasoning synopsis information finally reiterates a recommendation of “BUY BRK-B.”

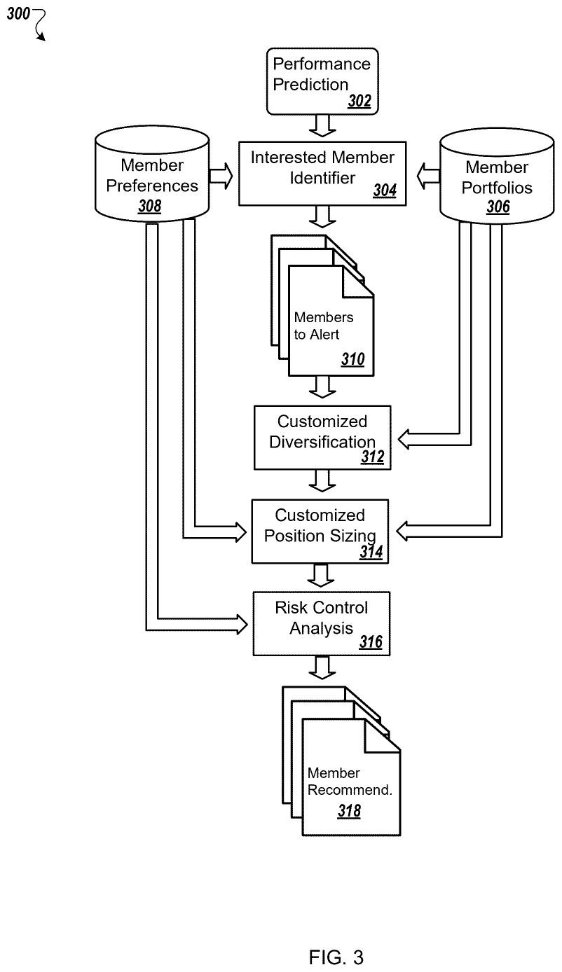

Returning to FIG. 2, the trade recommendation customizer 240, in some embodiments, determines a position, a timing, and/or a budget for investment by a user based on the user's current portfolio and/or the user's investment goals and/or preferences. The trade recommendation customizer 240, for example, may perform at least a portion of the operations described in relation to an example process 300 of FIG. 3.

Turning to FIG. 3, a flow diagram illustrates the example process 300 for determining a customized trade recommendation based on predicted performance of an investment vehicle. Aspects of process 300 may be performed, for example, by the investment asset trading recommender platform 102 of FIG. 1 and/or the trade recommendation customizer 240 of FIG. 2. The process 300 may be executed, for example, responsive to the process 200 of FIG. 2 generating the performance prediction 238.

In some implementations, the process 300 begins with an interested member identifier unit 304 obtaining a performance prediction 302 related to an investment asset. The performance prediction 302, for example, may include an estimated vector of movement of the investment asset (e.g., an increase or decrease in value within a specified time period). The performance prediction 302, or a separate data source, may further specify additional details regarding the investment asset such as, in some examples, a current position of the investment asset (e.g., a current stock price), an industry, a market segment, a geography, and/or an asset type (e.g., stock, e-currency, etc.).

In some implementations, the interested member identifier 304 accesses member portfolios 306 (e.g., user portfolios 142 of FIG. 1) and/or member preferences 308 (e.g., user information 144 of FIG. 1) to match the performance prediction 302 with a portion of members (e.g., investors 104 of FIG. 1) that may be interested in receiving a transaction recommendation related to the investment asset. In the event of a purchase recommendation, the member preferences 308, in one example, may include an available budget that can be matched to an estimated cost of transaction (e.g., based on the current value). In the event of a sale recommendation, the member portfolios 142 may be reviewed to identify a subset of members holding an interest in the investment asset. In yet another example, the interested member identifier 304 may match the timing of the performance prediction 302 (e.g., how soon the prediction should be acted upon) to timing preferences of the members, as referenced in the member preferences 308.

The interested member identifier 304, in some implementations, accesses a portion of the member preferences 308 generated through monitoring past behaviors of each member and/or the past behaviors themselves (e.g., an interactions log). For example, based on the user's past inputs and/or feedback related to investment criteria, one or more AI models may generate a prediction of whether each individual user would be interested in pursuing a particular opportunity. The AI model(s) may further produce reasoning regarding an individual's potential interest in an investment opportunity to provide to the user to support the user's decision-making regarding a particular opportunity.

The interested member identifier 304, in some implementations, generates a set of members to alert 310. The set of members to alert, may include, in some examples, member identifiers, alert preferences derived from the member preferences 308, and/or trading platforms associated with the individual members to alert 310.

The set of members to alert 310, in some implementations, is provided to a customized diversification unit 312. The customized diversification unit 312, for example, may perform operations described in relation to the portfolio structure analyzer 128 of FIG. 1. For example, in the event of a purchase recommendation, the customized diversification unit 312 may review the member portfolios 142 to identify a subset of members having portfolios indicative of a diversification gap matching the details of the investment asset. In the event of a sale recommendation, in another example, the customized diversification unit 312 may review the member portfolios 142 to identify a potential diversification gap that may be caused by selling the member's interest in the investment asset. The customized diversification unit 312, for example, may determine an opportunity for rebalancing and/or diversifying based on the proposed transaction.

In some implementations, the members to alert 310 and/or diversification data generated by the customized diversification unit 312 is provided to a customized position sizing unit 314. The customized position sizing unit 314, for example, may perform operations described in relation to the customized position sizer 130 of FIG. 1. The customized position sizing unit 314, for example, may access individual member portfolios 306 to determine a position size (e.g., number of shares, etc.) aligning with a size of the overall portfolio to maintain balance of the portfolio. In another example, the customized position sizing unit 314 may access the member preferences 308 to determine a position size based on budget and/or transaction preferences of individual members.

A risk control analysis unit 316, in some implementations, receives the members to alert 310, along with the diversification data and/or the position size data generated by the customized position sizing unit 314, and refines a recommended transaction based on member preferences 308. The risk control analysis unit 316, for example, may perform operations described in relation to the asset transaction recommender 126 of FIG. 1. In illustration, the risk control analysis unit 316 may analyze risk metrics (e.g., derived from past transactions performed by the member) and/or risk preferences (e.g., collected via a survey from the member) to adjust the position size data in accordance with a member's investment preferences. In another illustration, the risk control analysis unit 316 may analyze member preferences and/or past interactions of each member to adjust the timing recommendation in accordance with a member's investment behaviors, such as proposing a longer investment strategy that may have a lower reward but aligns with the member's lower risk appetite.

In some embodiments, the risk control analysis unit 316 tailors recommendations based on a set of member scenarios. In a first example, a short-term trader member may have member preferences and/or past interactions indicative of a desire to consider near-term opportunities. For a short-term trader recommendation, the risk control analysis unit 316 may use signal-driven filtering (e.g., based on performance metrics). The short-term trader recommendations may be gated using an overbought threshold. Further, the risk control analysis unit 316 may adjust trade recommendations in accordance with cash availability within a member account. In a second example, the risk control analysis unit 316 may identify long-term investor members having member preferences and/or past interactions indicative of a desire to maintain a diversified portfolio while retaining investment vehicles over a longer period of time. For the long-term investor member recommendations, the risk control analysis unit 316 may perform periodic rebalancing and disciplined position sizing.

In some implementations, the risk control analysis engine 316 generates a set of member recommendations, including refined position sizing, and forms a set of member recommendations 318. The member recommendations 318, for example, may be shared with the set of members to alert 310 by the user interface manager 132 of FIG. 1. The alert may include details of the performance prediction 302 such as, in some examples, the recommended timing for action, reasons for the recommendation, and/or details regarding the investment asset itself.

Although illustrated as a particular flow of operations, in other embodiments, the process 300 may include more or fewer operations. For example, the customized diversification engine 312 or another operational unit of the process 300 (e.g., the risk control analysis unit 316 or other unit not illustrated) may consider liquidity objectives of the member (e.g., as derived from the member preferences 308). Further, although the process 300 is illustrated as a particular series of operations, in some embodiments, certain operations may be performed in a different order and/or at least partially concurrently. For example, the customized diversification unit 312, customized position sizing unit 314 and risk control analysis unit 316 may be executed in a different order and/or in a concurrent or overlapping manner. Other modifications of the process 300 are possible.

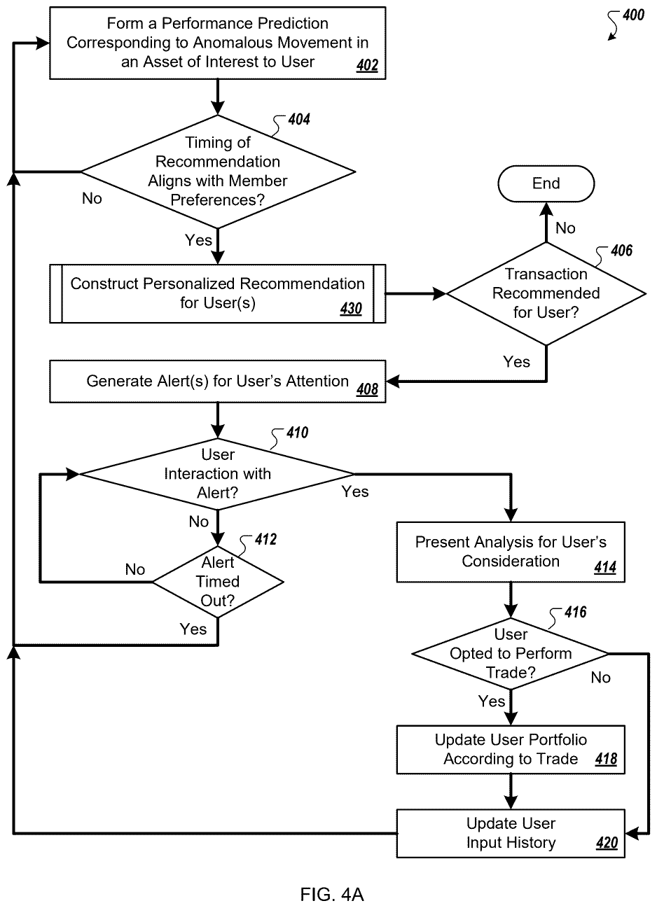

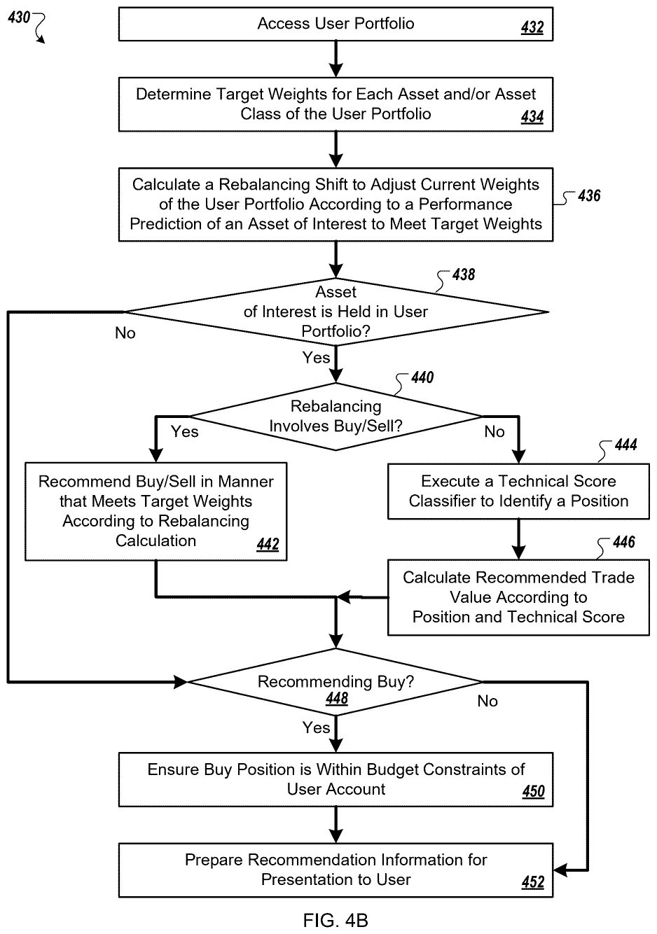

FIG. 4A is a flow chart of an example method 400 for providing users with customized transaction recommendations. Portions of method 400, for example, may be performed by aspects of the investment asset trading recommender platform 102 of FIG. 1, the process 200 of FIG. 2, and/or the process 300 of FIG. 3.

In some implementations, the method 400 begins with forming a performance prediction corresponding to anomalous movement in an asset of interest to at least one user (402). The asset may be considered to be of interest, for example, based on at least one investor or member (e.g., of the investment asset trading recommender platform 102) including the asset of interest in a portfolio (e.g., the user portfolios 142 and/or the member portfolios 306). In another example, the asset may be identified as an asset of interest in the member preferences (e.g., member preferences 308 of FIG. 3 and/or the user information 144 of FIG. 1) of at least one member (e.g., investors 104 of FIG. 1). In further examples, the asset may be subject of an upcoming initial public offering (IPO), included in one or more stock market indices, and/or mentioned as an asset to watch by one or more analysts (e.g., as derived from analyst data source(s) 108 of FIG. 1).

In an illustrative example, turning to FIG. 5C, a user may customize alert settings, such that predictions are considered by the user only if within the set parameters. As illustrated, the user may activate a threshold change alert 542 to elect to be alerted for predictions involving a threshold (e.g., 5%) level of predicted change in value. In another example, the user may activate a portfolio-only alert 544 to elect to be alerted only regarding assets already in the user's portfolio. Conversely, the user may activate an outside portfolio alert 546 to elect to be alerted only regarding assets not already included in the user's portfolio.

Returning to FIG. 4A, in some embodiments, anomalous movement is identified by an anomalous movement analyzer 122 of FIG. 1. The anomalous movement, for example, may be recognized using a portion of the process 200 as described in relation to FIG. 2.

In some embodiments, the performance prediction is formed at least in part as described in relation to the asset performance forecaster 124 of FIG. 1 and/or the process 200 of FIG. 2.

In some implementations, if the timing of the recommendation aligns with member preferences (404), a personalized recommendation is constructed for each user of the at least one user (430). As illustrated in an example user interface 540 of FIG. 5C, for example, the timing may be determined to align with member preferences based on a range (e.g., minimum and/or maximum) of time to a predicted change. A time until change alert setting 552, for example, allows the user to set a range of hours from a minimum of 1 hour to a maximum of 168 hours. The personalized recommendation, for example, may be formed as described in relation to the asset transaction recommender 126, the portfolio structure analyzer 128, and/or the customized position sizer 130 of FIG. 1 and/or the process 300 of FIG. 3. The timing analysis, for example, may be performed as described in relation to the asset transaction recommender 126 and/or the process 300 of FIG. 3. Turning to FIG. 4B, a flow chart illustrates a method 430 for constructing a personalized recommendation.

In some implementations, the method 430 begins with accessing a user portfolio (432). The user portfolio, for example, may include a present set of holdings of the user. The user portfolio, for example, may be one of the user portfolios 142 of FIG. 1 or one of the member portfolios 306 of FIG. 3.

In some implementations, target weights for each asset and/or asset class of the user portfolio are determined (434). The target weights, for example, may include inverse-volatility target weights, allowing each asset and/or asset class to be weighted in inverse proportion to the volatility of its return, such that more volatile assets are assigned lower weights. In another example, at least certain target weights may be calculated based at least in part on a risk-tier cap imposed to limit exposure to higher risk assets. The applied risk tiers, for example, may be derived from at least three (e.g., low, middle, high) risk categories. In some embodiments, the target weights are based at least in part on a customized investment strategy established via user settings (e.g., as stored in the user information 144 of FIG. 1 or the member preferences 308 of FIG. 3). For example, a user risk tolerance may be layered on the risk categories to adjust risk-tier caps according to user risk tolerance.

In some implementations, a rebalancing shift is calculated to adjust current weights of assets in the user portfolio in accordance with a performance prediction of an asset of interest to meet the target weights (436). The rebalancing shift, for example, is calculated to move current weights of the assets within the portfolio to the determined target weights.

In some implementations, if the asset of interest is already held in the user portfolio (438) and rebalancing would involve a buy or sell of the asset of interest (440), the buy or sell is recommended in a manner that meets the target weights according to the rebalancing calculation (442). For example, a number of shares recommended to buy or sell is calculated in a manner that rebalances the user portfolio toward the target weights.

If, instead, the asset of interest is held in the user portfolio (438) but rebalancing would not involve a buy or sell of the asset of interest (440), a technical-score classifier is executed to identify a recommended position (444). In this circumstance, for example, the rebalancing shift calculated (436) resulted in a neutral position. Thus, a technical-score classifier is executed to identify the recommended position relative to the asset of interest (e.g., buy, add, trim, sell, or hold). The asset's technical score is a metric representing the asset's price trend (e.g., momentum and direction of price movement). The technical score, for example, may be represented on a confidence scale (e.g., 0 to 100). The technical-score classifier may classify ranges within the confidence scale as corresponding to various asset positions. For example, bullish momentum may correspond to a buy classifier, while bearish momentum may correspond to a sell classifier.

In some implementations, a recommended trade value is calculated according to the position and the technical score (446). The value of the technical score, for example, may be translated to a scaling factor for adjusting the size of the position (e.g., how many shares to buy or sell, etc.). In some embodiments, the recommended trade value is bounded by a cap on total portfolio value. For example, a percentage of portfolio value cap may be applied such that recommended transactions are scaled to a maximum percentage (e.g., five, seven, ten, etc.) of overall portfolio value. The recommended trade value, in some embodiments, is bounded by a cap on the total value of the asset presently held in the user's portfolio. For example, rather than recommended to sell all shares, the recommendation may be limited to advising to sell up to X % (e.g., twenty, thirty, fifty, etc.) of the user's position in relation to the asset of interest.

In some implementations, if the recommendation is a buy recommendation (448), the buy position is analyzed to ensure the value is within budget constraints of a user account (450). For example, available funds (e.g., cash account) are calculated to identify the amount of money the user has allocated for building the user portfolio. As illustrated in an example user interface 560 of FIG. 5D, the amount of cash available 562 may be calculated based on multiple fund sources 564, including trims (e.g., sales) 564a and new capital 564b. If the initial buy recommendation exceeds the available funds, the recommended trade may be scaled to satisfy the budget. For example, as illustrated in the example user interface 560 of FIG. 5D, buy orders have been globally scaled 566 by 0.855 to result in an amount of cash used 568 being less than the amount of cash available 562.

In some embodiments, in addition to meeting budget constraints with the buy recommendation, a monetary buffer is calculated (e.g., a remaining amount of available funds after the recommended trade has been executed). As illustrated in the example user interface 560 of FIG. 5D, for example, a cash buffer 570 is calculated as $12.

In some implementations, recommendation information is prepared for presentation to the user (452). The recommendation information, for example, may be prepared by the asset transaction recommender 126 of FIG. 1 and/or the trade recommendation customizer 240 of FIG. 2. The recommendation information, in some embodiments, includes human-readable reasoning prepared by a foundational artificial intelligence model based on prompting the foundational model with a structured facts object representing the metrics considered in evaluating the asset of interest to produce the recommendation and a template (e.g., fill-in-the-blank) for forming the reasoning. The considered metrics, in some examples, may include an action, a monetary value, one or more indicators (e.g., RSI, MACD, etc.), at least one quantification of momentum (e.g., across one week, two weeks, one month, three months, etc.), one or more news/earnings characteristics, a forecast, and/or an alpha value. In some embodiments, the recommendation information is formulated using a standard template (or one of a set of standard templates) with variables filled in using the considered metrics. The prepared information, in some examples, may be integrated into a graphical user interface for presentation by the user interface manager 132 and/or organized for transmittal via a network by the investment platform integration unit 134 of FIG. 1 (e.g., for preparation of a graphical user interface by an external entity).

Although described in relation to a particular set of operations, in other embodiments, the method 430 may include more or fewer operations. For example, in some embodiments, when the asset of interest is not yet held in the user portfolio (438) and the recommendation is buy, the alpha of the asset of interest and/or the stock indicators associated with the asset of interest may be evaluated in view of the user's risk appetite to determine a buy position relative to the target weights for the user portfolio. Further, although described in relation to a particular order of operations, in other embodiments, certain operations of the method 430 may be performed in a different order and/or concurrently. For example, while, for simplicity sake, the method 430 relates to a single asset of interest, in other embodiments, multiple assets of interest may be considered simultaneously, such that recommendations and available budget may be formulated based on the combined outcome of the recommendation. In illustration, as shown in the example user interface 560 of FIG. 5D, a sell order 572 and two buy orders 574a,b are recommended, and the cash buffer total 570 takes into account all proposed orders. Other modifications of the method 430 are possible.

Returning to FIG. 4A, in some implementations, if the personalized recommendation corresponds to recommending a transaction for the user (406), alerts are generated for the attention of each user having a personalized recommendation (408). The alert, for example, may be distributed as described in relation to the user interface manager 132 of FIG. 1. The alert may identify the investment asset. Further, the alert may identify a recommended transaction type (e.g., buy, sell, short, etc.), a predicted change in value, and/or a recommended timeframe to take action. The contents of the alert may be based in part on user settings. For example, as illustrated in the example user interface 540 of FIG. 5C, an alert content setting 548 designates whether to include the predicted change in the alert. Turning to FIG. 5A, in an illustrative example, an example user interface 500 presents a set of alerts 502, including a predicted return alert 502a and a predicted drop alert 502b, presented on a display 504 of a mobile computing device 506 (e.g., smart phone). The user may select one of the alerts 502a, 502b to learn additional details regarding the predicted movement in the corresponding investment asset.

Returning to FIG. 4A, in some implementations, if the user does not interact with the alert (410), the alert may remain active until it has timed out (412). The timing of the alert, for example, may correspond with a timing of the predicted movement in asset value, for example as discussed in relation to the performance prediction 238 of FIG. 2.

In some implementations, if a user interaction is received with the alert (410), analysis regarding the alert is presented for the user's consideration (414). The analysis, in some examples, may include a portion of reasoning derived through historic performance analysis (e.g., by the price movement analyzer 204 of FIG. 2), sentiment analysis (e.g., by the investment vehicle sentiment analyzer 212 of FIG. 2), and/or economic analysis (e.g., by the fundamental economic analyzer 220 of FIG. 2). The analysis, further, may include reference to external sources such as, in some examples, analyst publications (e.g., from the analyst ratings source(s) 216 of FIG. 2), earning reports (e.g., from the earnings report source(s) 222 of FIG. 2) and/or news reports (e.g., from the investment vehicle news source(s) 214 of FIG. 2). In additional examples, the analysis may include reasoning applied in relation to customizing the recommendation, such as by the trade recommendation customizer 240 of FIG. 2, the customized diversification engine 312 of FIG. 2, the customized position sizing engine 314 of FIG. 3, and/or the risk control analysis engine 316 of FIG. 3.

The scope and content of the analysis, in some embodiments, is based at least in part on user settings. For example, as illustrated in the example user interface 540 of FIG. 5C, an elaborated reasoning setting 550 provides the user with the opportunity to elect whether elaborated reasoning is presented with the recommendation.

Turning to FIG. 5B, an example user interface 520 presents prediction analysis 522 including a technical analysis section 522a describing reasoning related to price trends, a sentiment analysis section 522b describing reasoning related to sentiment trends, and a fundamental analysis section 522c describing reasoning related to corporate economic trends. Further, the example user interface 520 includes a customized analysis section 524 describes reasoning behind a particular recommended position for the user to take in relation to the investment asset (e.g., a $1,000 short call based on the user's settings, risk tolerance, previous investments, and diversification).

Returning to FIG. 4A, if the user opts to perform a transaction (416), in some implementations, the user portfolio is updated according to the transaction (418). The user may perform a transaction, as illustrated in FIG. 5B, by selecting a transaction control 526 via the user interface 520. In other examples, the user may perform a transaction via a separate mechanism (e.g., trading platform app, investment web site, etc.) and report (e.g., via a user follow-up survey) to the recommendation platform regarding the performed transaction. In accordance with the parameters of the actual transaction (e.g., the value and position opted by the user), for example, a copy of the user's investment portfolio may be updated to reflect the user's present investments. The parameters, for example, may be derived through the investment platform integration unit 134 of FIG. 1. The portfolio and member information collector 136 of FIG. 1, for example, may update the user portfolio data 142.

In some implementations, whether or not the user opted to perform the trade (416), the user input history is updated based on the user interaction (420). The user interface manager 132 of FIG. 1, for example, may update the historic user interactions with recommendations data 154.

In some implementations, the method 400 repeats as performance predictions are generated (402). As illustrated in FIG. 5A, this may result in multiple alerts pending consideration by a given user.

Although described in relation to a particular set of operations, in other embodiments, the method 400 may include more or fewer operations. For example, the timing of recommendation (404) may not be an aspect of certain implementations. In another example, another factor, such as minimum budget, may be considered prior to constructing a personalized recommendation. In embodiments where transactional information is not automatically available (e.g., the user cannot place a trade through the user interface presenting the recommendation), rather than updating the user portfolio according to the trade (418), the method 400 may query the user regarding whether the user acted on the recommendation and, if so, what action, if any, was taken. The user portfolio may be updated in accordance with this interaction (e.g., survey).

Further, although described in a particular order of operations, in other embodiments, certain operations of the method 400 may be performed in a different order and/or concurrently. For example, an alert may be generated (408) based on the performance prediction, while the personalized recommendation (406) is determined in real-time or near real-time responsive to user interaction with the alert (410). In this manner, the personalized recommendation may take into account any recent transactions that would impact the user's portfolio contents and/or available budget. Other modifications of the method 400 are possible.

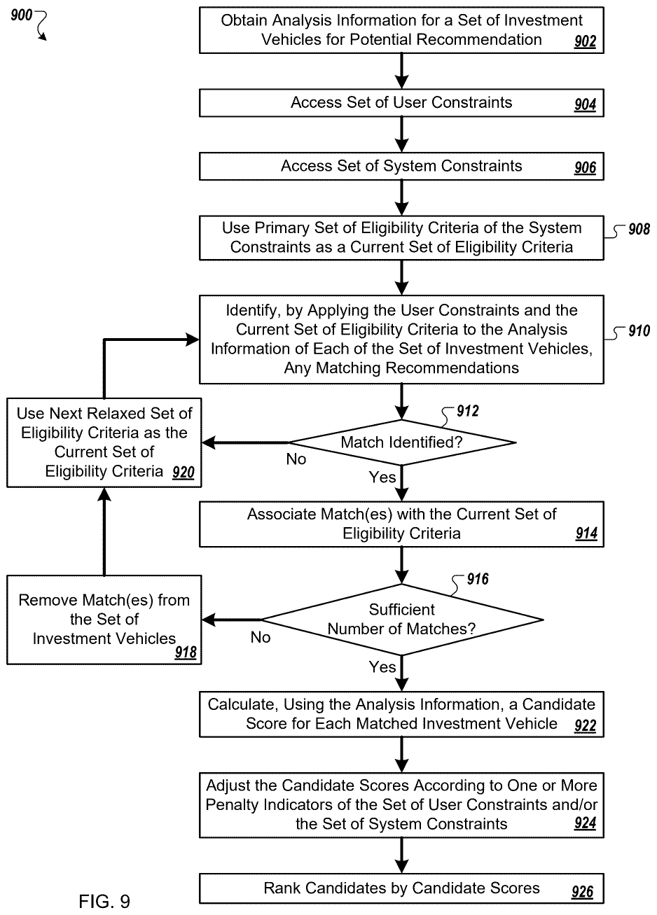

In some implementations, after forming a performance prediction (402) and prior to constructing the personalized recommendation for users (430), the candidate investment vehicles are analyzed to identify a set of investment vehicles to present as recommended investment vehicles. The asset transaction recommender 126, for example, may evaluate assets in view of system constraints and/or member constraints to identify qualifying anomalous movements for selection for forming trade recommendations. Turning to FIG. 9, a flow chart illustrates an example method 900 for identifying a set of candidate investment vehicles for forming recommendations.

In some implementations, the method 900 begins with obtaining analysis information for a set of investment vehicles for potential recommendation (902). The analysis information, in some examples, may include the historic investment asset performance data 146, the historic sentiments data 148, the historic entity performance data 150, and/or the historic asset performance forecasts data 152 of FIG. 1, and/or the performance predictions 238 generated by the performance forecast analyzer of FIG. 3. The analysis information may include scores and/or performance predictions, along with confidence values associated with each (e.g., as determined by one or more machine learning models and/or foundational models). The analysis information, for example, may be provided by the forecast outcome analyzer 138 of FIG. 1 and/or the performance forecast analyzer 232 of FIG. 2.

In some implementations, a set of user constraints is accessed (904). The set of user constraints may include member settings such as, in some examples, a risk tolerance level, a timeframe (time horizon) and/or other user preferences. Further, the set of user constraints may include a budget (e.g., cash available within an associated account). The set of user constraints, for example, may be maintained in the user information 144 of FIG. 1 and/or the member preferences 308 of FIG. 3.

In some implementations, a set of system constraints is accessed (906). The system constraints, for example, may include recommendation candidate eligibility criteria, system per-item trade caps, and/or systemwide concentration limits. The set of system constraints may be accessed, for example, from the data repository 140 of FIG. 1.

In some implementations, a primary set of eligibility criteria of the set of system constraints is used as a current set of eligibility criteria (908). The primary set of eligibility criteria, in some examples, may include a first momentum threshold, a first overbought penalty threshold, and/or a first confidence threshold.

In some implementations, the user constraints and the current set of eligibility criteria are applied to the analysis information of each of the set of investment vehicles to identify any matching recommendations (910). Zero or more matches may be discovered. For example, the set of investment vehicles for potential recommendation may include dozens or over a hundred potential investment vehicles analyzed by the investment asset trading recommender platform 102 of FIG. 1 for evidence of anomalous movement that may trigger a trade recommendation. However, the primary set of eligibility criteria may be set to discover the most promising of all of the investment vehicles and, thus, may act as a rigorous filter.

In some implementations, if at least one match is identified (912), the identified match(es) are associated with the current set of eligibility criteria (914). In this manner, the matches are tagged with a corresponding tier of eligibility criteria. The association, for example, can be used to promote those matches in the user recommendations.

In some implementations, if a sufficient number of matches has not been discovered (916), the most recent match(es) are removed from the set of investment vehicles (918) and a next relaxed set of eligibility criteria is used as the current set of eligibility criteria (920). The sufficient number of matches, for example, may be based on the set of system constraints (e.g., a default number of matches). In another example, the sufficient number of matches may be based on the set of user constraints (e.g., a preferences setting for reviewing more or fewer recommendations). The most recent matches may be removed from the set of investment vehicles to allow for a remainder of the investment vehicles to be reevaluated using the next relaxed set of eligibility criteria. The next relaxed set of eligibility criteria may include, for example, a second momentum threshold, a second penalty threshold, and/or a second confidence threshold. The set of system constraints, for example, may include three or more tiers or levels of eligibility criteria for evaluating potential recommendations.

In some implementations, operations 910-916 are repeated until a sufficient number of matches is determined (916).

In some implementations, a candidate score is calculated for each matched investment vehicle using the analysis information for the matched investment vehicle (922). The candidate score, for example, may represent a weighted combination of sentiment, performance, and economic analysis results (e.g., as determined by the price movement analyzer 204, the investment vehicle sentiment analyzer 212, and the fundamental economic analyzer 220 of FIG. 2). The candidate score may be further based on the set of user constraints (e.g., risk tolerance, timeframe, etc.). The candidate scores, for example, may be calculated by the asset transaction recommender 126 of FIG. 1 and/or the trade recommendation customizer 240 of FIG. 2. The candidate scores, in some embodiments, represent an adjustment of initial (standard) scores based on the user constraints.

In some implementations, the candidate scores are adjusted according to one or more penalty indicators of the set of system constraints and/or the set of user constraints (924). The penalty indicators, in some examples, may include an overbought threshold, a concentration threshold, and/or other risk flags applied to each individual candidate investment vehicle. The candidate scores, for example, may be adjusted by the asset transaction recommender 126 of FIG. 1 and/or the trade recommendation customizer 240 of FIG. 2.

In some implementations, the candidates are ranked by the candidate scores (926). The candidates may be further ranked based in part on the set of eligibility criteria used to identify the candidate as a match. The candidates may be ranked, for example, to determine an order of presentation to an end user. The candidates may be ranked, in another example, to identify which candidates to remove in reducing a final number of matches to meet a maximum results setting (e.g., according to the set of system constraints and/or the set of user constraints).

Although described in relation to a particular set of operations, in other embodiments, the method 900 may include more or fewer operations. For example, in addition to determining whether a sufficient number of matches have been identified (916), in some embodiments, the method 900 may further determine if a next set of relaxed eligibility criteria is available. Further, although described in a particular order of operations, in other embodiments, certain operations of the method 900 may be performed in a different order and/or concurrently. For example, the analysis information (902), the set of user constraints (904), and/or the set of system constraints (906 may be accessed in a different order or concurrently. Other modifications of the method 900 are possible.

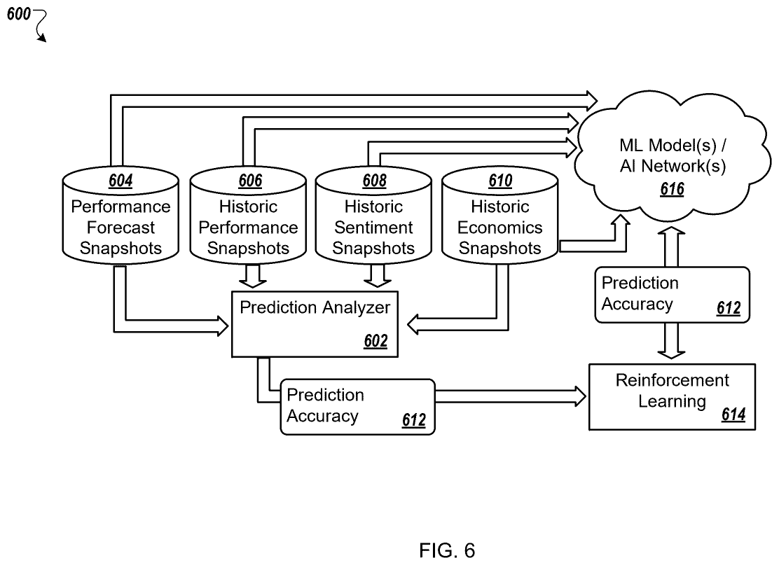

FIG. 6 is a flow diagram of an example process 600 for analyzing outcomes related to past predictions and member interactions therewith. Portions of the process 600, for example, may be performed by the investment asset trading recommender platform 102. The example process 600, for example, may be used to train and/or fine-tune the ML model(s) and/or AI network(s) 160 of FIG. 1.

In some implementations, the process 600 begins with obtaining, by a prediction analyzer 602, a set of performance forecast snapshots 604 detailing past performance predictions of a set of investment assets and a set of historic performance snapshots 606 detailing actual past performance of the set of investment assets. The prediction analyzer 602, for example, may perform operations described in relation to the forecast outcome analyzer 138 of FIG. 1. The performance forecast snapshots 604, for example, may be the historic asset performance forecasts data 152 of FIG. 1 and/or the performance forecasts snapshots 236 of the process 200 of FIG. 2. The set of historic performance snapshots 606, in some examples, may be the historic investment asset performance data 146 of FIG. 1 or the historic performance snapshots 210 of the process 200 of FIG. 2.

The prediction analyzer 602, in some implementations, applies pattern analysis to compare the predicted performance represented by the performance forecasts snapshots 604 to the actual performance represented by the historic performance snapshots 606. The prediction analyzer 602 may generate a set of prediction accuracy data 612 including accuracy metrics related to predictions. The accuracy metrics, in some examples, may include proximity of predicted results to actual results metrics representing accuracy in predicting overall movement in value of the assets, prediction vector accuracy metrics representing accuracy in predicting a direction of movement in value of the investment assets, and/or timing of predicted results metrics representing accuracy in predicting a timing of the investment asset achieving the predicted value. Further, the prediction accuracy data 612 may include a set of actual results for use in comparing to the predicted results of the performance forecast snapshots 604.

The accuracy metrics, in some embodiments, are broken down by reasoning factors, such as the asset performance trends, sentiment trends, and/or entity economic trends (e.g., as analyzed by the process 200 of FIG. 2). As illustrated, the prediction analyzer 602 may access historic sentiment snapshots 608 (e.g., the historic sentiments data 148 of FIG. 1 and/or the historic sentiment snapshots 218 of FIG. 2) and/or historic economics snapshots 610 (e.g., the historic entity performance data 150 of FIG. 1 and/or the historic performance snapshots 210 of FIG. 2). In this manner, the prediction analyzer 602 may analyze performance in view of the type of data relied upon to reach the predicted conclusions. The prediction analyzer 602, for example, may apply one or more machine learning analysis techniques and/or pattern analysis techniques to generate likelihood of accuracy of results based on the composition (asset value trends, sentiment trends, and/or entity economic trends) of the foundation of the analysis.

In some implementations, a reinforcement learning engine 614 applies the prediction accuracy metrics 612 to training and/or fine-tuning the ML model(s) and/or AI network(s) 616 applied in generating performance predictions (e.g., by the asset performance forecaster 124 of FIG. 1 and/or the performance forecast analyzer 232 of FIG. 2). The reinforcement learning engine 614, for example, may perform operations described in relation to the forecast outcome analyzer 138 of FIG. 1. The ML model(s) and/or AI network(s) 616, for example, may obtain data from the performance forecast snapshots 604, historic performance snapshots 606, historic sentiment snapshots 608, and/or historic economics snapshots 610 to support reinforcement learning. The reinforcement learning engine 614, in illustration, may review accurate predictions from previous recommendations to apply positive reinforcement truth data to the ML model(s) and/or AI network(s) 616. In another example, the reinforcement learning engine 614 may supply further data that may provide reasons for a past false prediction (e.g., negative truth data), increasing the knowledge of the ML model(s) and/or AI network(s) 616 to produce more accurate future predictions.

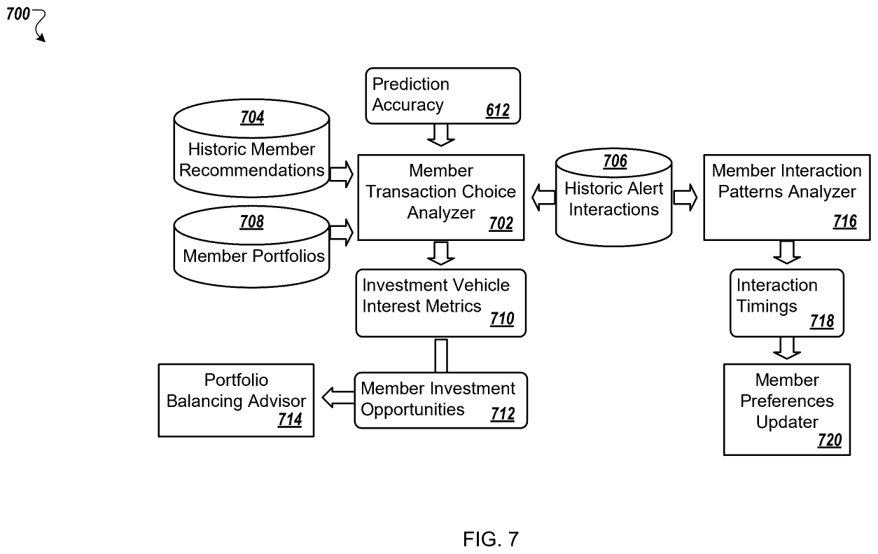

Turning to FIG. 7, in some implementations, the prediction accuracy data 612 is provided to a member transaction choice analyzer 702 to analyze patterns in member interest and disinterest in the presented recommendations in view of outcomes. FIG. 7 illustrates a flow diagram of an example process 700 for analyzing member interactions with transaction recommendations. The member transaction choice analyzer 702, for example, may perform some of the operations described in relation to the learning feedback applicator 139 of FIG. 1.

The member transaction choice analyzer 702, in some implementations, accesses historic member recommendations 704 and historic alert interactions 706 to analyze choices made by members in view of historic recommendations, and how these choices may have positively or negatively affected the member's investment holdings. For example, the member transaction choice analyzer 702 may analyze the positive interactions (e.g., transactions placed and/or other indication from the member that the information as useful) in comparison to the negative interactions (e.g., declining to place a transaction and/or otherwise indicating that the information was note useful) to determine patterns in investment vehicle category. The member transaction choice analyzer 702, for example, may identify comfort zones and/or blind spots, indicating asset classes, geographic regions, investment vehicle types, and/or business sectors favored by the member and/or avoided by the member. The member transaction choice analyzer 702, for example, may generate investment vehicle metrics 710 including metrics representing propensities for the investor to react positively and/or negatively relative to various investment categories. In some embodiments, the member transaction choice analyzer 702 analyzes member preferences and/or behaviors to establish an ideal portfolio matching a member's identified investment preferences and strategies. The ideal portfolio, for example, may identify investment classifications (e.g., asset classes and/or asset types, sets of assets sharing key commonalities that align with the member preferences and/or behaviors, etc.) with a corresponding percentage holding attributed to each investment classification. The member transaction choice analyzer 702 may then compare the member's current portfolio to the ideal portfolio to recognize significant differences. Further, the member transaction choice analyzer 702 may produce a set of member investment opportunities 712 identifying the “blind spots” in investment behaviors that may lead to a more diverse, balanced, and/or better performing portfolio. For example, the member transaction choice analyzer 702 may provide a suggestion to the member of a particular asset or collection of assets to introduce to (or conversely remove from) the member's present portfolio to better align with the ideal portfolio. The suggestion, in illustration, may include reasoning related to the ideal portfolio and how the particular asset or collection of assets aligns with the member's investment strategy and interests.

The member transaction choice analyzer 702, in some implementations, analyzes the historic member recommendations 704 in view of the historic alert interactions 706 to determine metrics regarding engagements (e.g., transactions executed and/or indication of approval of the member) corresponding to accurate (e.g., value-producing or loss-avoiding) predictions and/or metrics regarding engagements corresponding to inaccurate (e.g., loss-producing or resulting in lack of opportunity for increase in value) predictions. For example, the member transaction choice analyzer 702 may analyze the propensity for members to follow “good” advice in comparison to following “bad” advice. The engagement metrics, for example, may be included in the investment vehicle interest metrics 710.

In some implementations, the member transaction choice analyzer 702 accesses member portfolios 708 for at least a portion of the members (e.g., those opting to share portfolio information) to analyze actual investment outcome in view of a potential investment outcome had the recommendation(s) been followed. For example, based on actual outcomes (e.g., derived from the prediction accuracy data 612) and the historic member recommendations 704, the member transaction choice analyzer 702 may determine whether the member would have been in a better position had the member followed recommendations that were missed, ignored, and/or otherwise identified as not being of interest to the member. The potential investment outcome data, for example, may be included in the investment vehicle interest metrics 710. The member, for example, may be presented with one or more metrics, such as an investment success statistic, for review. Further, the analysis performed by the member transaction choice analyzer 702 may be used in increasing accuracy of the ML model(s) and/or AI network(s) (e.g., provided to the reinforcement learning engine 614 of FIG. 6).

In some implementations, the investment vehicle interest metrics 710 and/or the member investment opportunities data 712 are accessed by a portfolio balancing advisor engine 714. The portfolio balancing advisor 714, for example, may generate textual and/or graphical analyses of the member's investment propensities, interest propensities, and/or blind spots to advise on opportunities for expansion outside of the investor's comfort zone. The portfolio balancing advisor 714, for example, may generate content for presentation in an email and/or via a user interface. The content, for example, may be presented by the user interface management 123 of FIG. 1.

In some implementations, a member interaction patterns analyzer 716 analyzes patterns in member interactions to determine a set of interaction timings 718 reflecting the habits of a given member in reviewing alerts. The interaction timings 718, in some examples, can include times of day, days of the week, delay between alert release and recognition, style of alert(s) engaged (e.g., via app interface, via email, via text message, etc.). The interaction timings 718, for example, may reflect the individual user's habits in engaging with the investment asset trading recommender platform 102.

In some implementations, the interaction timings 718 are provided to a member preferences updater unit 720 for updating one or more alert settings to better style the alerts to the habits of the user. The member preferences updater unit 720, for example, may apply one or more ML models and/or AI networks to align alert settings with member preferences (e.g., such as timeframe or size of movement) so that the member's account settings reflect the member preferences, and recommendations are supplied in accordance with a member's interactions, investment choices, and system feedback. For example, based upon the delay between alert release and recognition, the member preferences updater 720 may adjust the alert settings to suppress alerts that must be acted upon in a short timeframe. The member preferences updater 720, for example, may adjust a portion of the user information 144 of FIG. 1.

Reference has been made to illustrations representing methods and systems according to implementations of this disclosure. Aspects thereof may be implemented by computer program instructions. These computer program instructions may be provided to a processor of a general-purpose computer, special purpose computer, or other programmable data processing apparatus and/or distributed processing systems having processing circuitry, such that the instructions, which execute via the processor of the computer or other programmable data processing apparatus, create means for implementing the functions/operations specified in the illustrations.

One or more processors can be utilized to implement various functions and/or algorithms described herein. Additionally, any functions and/or algorithms described herein can be performed upon one or more virtual processors. The virtual processors, for example, may be part of one or more physical computing systems such as a computer farm or a cloud drive.

Aspects of the present disclosure may be implemented by software logic, including machine readable instructions or commands for execution via processing circuitry. The software logic may also be referred to, in some examples, as machine readable code, software code, or programming instructions. The software logic, in certain embodiments, may be coded in runtime-executable commands and/or compiled as a machine-executable program or file. The software logic may be programmed in and/or compiled into a variety of coding languages or formats.

Aspects of the present disclosure may be implemented by hardware logic (where hardware logic naturally also includes any necessary signal wiring, memory elements and such), with such hardware logic able to operate without active software involvement beyond initial system configuration and any subsequent system reconfigurations (e.g., for different object schema dimensions). The hardware logic may be synthesized on a reprogrammable computing chip such as a field programmable gate array (FPGA) or other reconfigurable logic device. In addition, the hardware logic may be hard coded onto a custom microchip, such as an application-specific integrated circuit (ASIC). In other embodiments, software, stored as instructions to a non-transitory computer-readable medium such as a memory device, on-chip integrated memory unit, or other non-transitory computer-readable storage, may be used to perform at least portions of the herein described functionality.

Various aspects of the embodiments disclosed herein are performed on one or more computing devices, such as a laptop computer, tablet computer, mobile phone or other handheld computing device, or one or more servers. Such computing devices include processing circuitry embodied in one or more processors or logic chips, such as a central processing unit (CPU), graphics processing unit (GPU), field programmable gate array (FPGA), application-specific integrated circuit (ASIC), or programmable logic device (PLD). Further, the processing circuitry may be implemented as multiple processors cooperatively working in concert (e.g., in parallel) to perform the instructions of the inventive processes described above.

The process data and instructions used to perform various methods and algorithms derived herein may be stored in non-transitory (i.e., non-volatile) computer-readable medium or memory. The claimed advancements are not limited by the form of the computer-readable media on which the instructions of the inventive processes are stored. For example, the instructions may be stored on CDs, DVDs, in flash memory, random access memory (RAM), read-only memory (ROM), programmable ROM (PROM), erasable PROM (EPROM), electrically erasable PROM (EEPROM), dynamic random-access memory (DRAM), non-volatile random-access memory (NVRAM), static random-access memory (SRAM), hard disk or any other information processing device with which the computing device communicates, such as a server or computer. In another example, the memory may be incorporated into the processing circuitry as an on-chip memory unit. The processing circuitry and stored instructions may enable the computing device to perform, in some examples, the process 200 of FIG. 2, the process 300 of FIG. 3, the method 400 of FIG. 4A, the method 430 of FIG. 4B, the process 600 of FIG. 6, and/or the process 700 of FIG. 7.

These computer program instructions can direct a computing device or other programmable data processing apparatus to function in a particular manner, such that the instructions stored in the computer-readable medium produce an article of manufacture including instruction means which implement the function/operation specified in the illustrated process flows.

Embodiments of the present description rely on network communications. As can be appreciated, the network can be a public network, such as the Internet, or a private network such as a local area network (LAN) or wide area network (WAN) network, or any combination thereof and can also include PSTN or ISDN sub-networks. The network can also be wired, such as an Ethernet network, and/or can be wireless such as a cellular network including EDGE, 3G, 4G, and 5G wireless cellular systems. The wireless network can also include Wi-Fi®, Bluetooth®, Zigbee®, or another wireless form of communication. The network, for example, may support communications between the investment asset trading recommender platform 102 of FIG. 1 and the economic indicator data source(s) 110, the news and analyst data source(s) 108, the price data source(s) 106, the investor(s) 104, and/or the investment platform(s) 112. In another example, the network may support communications between the investment asset trading recommender platform 102 and the data repository 140 of FIG. 1. Additionally, the network may support communications between the investment asset trading recommender platform 102 and the ML model(s) and/or AI network(s) 160 of FIG. 1.

The computing device, in some embodiments, further includes a display controller for interfacing with a display, such as a built-in display or LCD monitor. A general purpose I/O interface of the computing device may interface with a keyboard, a hand-manipulated movement tracked I/O device (e.g., mouse, virtual reality glove, trackball, joystick, etc.), and/or touch screen panel or touch pad on or separate from the display. The display controller and display may enable presentation of the screen shots illustrated, in some examples, in FIG. 5A through FIG. 5C.

Moreover, the present disclosure is not limited to the specific circuit elements described herein, nor is the present disclosure limited to the specific sizing and classification of these elements. For example, the skilled artisan will appreciate that the circuitry described herein may be adapted based on changes in battery sizing and chemistry or based on the requirements of the intended back-up load to be powered.

The functions and features described herein may also be executed by various distributed components of a system. For example, one or more processors may execute these system functions, where the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system, in some examples, may be received via direct user input and/or received remotely either in real-time or as a batch process.

Although provided for context, in other implementations, methods and logic flows described herein may be performed on modules or hardware not identical to those described. Accordingly, other implementations are within the scope that may be claimed.

In some implementations, a cloud computing environment, such as Google Cloud Platform™ or Amazon™ Web Services (AWS™), may be used perform at least portions of methods or algorithms detailed above. The processes associated with the methods described herein can be executed on a computation processor of a data center. The data center, for example, can also include an application processor that can be used as the interface with the systems described herein to receive data and output corresponding information. The cloud computing environment may also include one or more databases or other data storage, such as cloud storage and a query database. In some implementations, the cloud storage database, such as the Google™ Cloud Storage or Amazon™ Elastic File System (EFS™), may store processed and unprocessed data supplied by systems described herein. The databases may include one or more vector databases organized to store high-dimensional data points each mathematically representing the meaning and context of at least a portion of an original file (e.g., text document, audio file, rich media file, image file, photograph, video file, etc.). The vector database(s), for example, may incorporate a set of search algorithms for performing vector similarity searches such as, in some examples, an exhaustive k-nearest neighbors (KNN) algorithm, an approximate nearest neighbor (ANN) algorithm, a Locality Sensitive Hashing (LSH) algorithm, a Hierarchical Navigable Small World (HNSW), and/or an Inverted File Index (IVF) algorithm. The vector database(s), further, may include an embedded query engine for submitting a request to the vector database(s). Unlike traditional databases and query systems, for example, a vector database query may respond with a set of similar assets (e.g., objects or items) to the query information based on similarity metrics (e.g., as calculated by the set of search algorithms). The vector database(s), in some examples, may be implemented by Microsoft® Azure Cosmos DB or Cloudflare Vectorize by Cloudflare, Inc. of San Francisco, CA. For example, portions of the data repository 140 of FIG. 1, the economic indicator source(s) 206, the stock market price data source(s) 208, the investment vehicle news source(s) 214, the analyst ratings source(s) 216, the earnings reports source(s) 222, the historic performance snapshots 210, the historic sentiment snapshots 218, the historic economics snapshots 224, the anomalous movement snapshots 228, and/or the performance forecast snapshots 236 of FIG. 2, the member preferences 308 and/or the member portfolios 306 of FIG. 3, the performance forecast snapshots 604, the historic performance snapshots 606, the historic sentiment snapshots 608, and/or the historic economics snapshots 610 of FIG. 6, and/or historic member recommendations 704, the member portfolios 708, and/or the historic alert interactions 706 of FIG. 7 may be maintained in a database structure.

The systems described herein may communicate with the cloud computing environment through a secure gateway. In some implementations, the secure gateway includes a database querying interface, such as the Google BigQuery™ platform or Amazon RDS™. The data querying interface, for example, may support access by the investment asset trading recommender platform 102 to the price data source(s) 106, the news and analyst data source(s) 108, and/or the economic indicator data source(s) 110.

In some implementations, an edge server is used to transfer data between one or more computing devices and a cloud computing environment according to various embodiments described herein. The edge server, for example, may be a computing device configured to execute processor intensive operations that are sometimes involved when executing machine learning processes, such as the asset performance, entity sentiment, entity performance, and/or anomalous movement analysis operations performed by the investment asset trading recommender platform in coordination with the ML model(s) and/or AI network(s) 160 of FIG. 1, the analysis operations performed in the process 200 of FIG. 2, the analysis and reinforcement learning operations performed by the process 600 in coordination with the ML model(s) and/or AI network(s) 616 of FIG. 6, and/or the analysis operations performed by the process 700 of FIG. 7. An edge server may include, for example, one or more GPUs that are capable of efficiently executing matrix operations as well as substantial cache or other high-speed memory to service the GPUs. An edge server may be a standalone physical device. An edge server may be incorporated into other computing equipment, such as a laptop computer, tablet computer, medical device, or other specialized computing device. Alternatively or additionally, an edge server may be located within a carrying case for such computing equipment. An edge server, in a further example, may be incorporated into the communications and processing capabilities of a mobile unit such as a vehicle or drone, or may otherwise be located within the mobile unit.

In some implementations, the edge server communicates with one or more local devices to the edge server. The edge server, for example, can be used to move a portion of the computing capability traditionally shifted to a cloud computing environment into the local environment so that any computation intensive data processing and/or analytics required by the one or more local devices can run accurately and efficiently. In some embodiments, the edge server is used to support the one or more local devices in the absence of a connection with a remote computing environment. The edge server may be configured to communicate with the one or more local devices directly or via a network. For instance, the edge server can include a private wireless network interface, a public wireless network interface, and/or a wired interface through which the edge server can communicate with the one or more local devices. In some embodiments, certain local devices may be configured to communicate indirectly with the edge server, for example via another local device. Further, the edge server may be configured to communicate with a remote computing (e.g., cloud) environment via one or more public or private wireless network interfaces.

In some implementations, the asset performance analyzer 116, the entity sentiment analyzer 118, the entity performance analyzer 120, the anomalous movement analyzer 122, the asset performance forecaster 124, the portfolio structure analyzer 128, the forecast outcome analyzer 138, and/or the learning feedback applicator 139 of FIG. 1 may be configured to be performed in part by an edge server or a device interoperating with an edge server. The device interoperating with the edge server, for example, may share processing functionality with the edge server via one or more APIs implemented by the processes.

The systems described herein may include one or more artificial intelligence (AI) neural networks for performing automated analysis of data. The AI neural networks, in some examples, can include a synaptic neural network, a deep neural network, a transformer neural network, and/or a generative adversarial network (GAN). The AI neural networks may be trained using one or more machine learning techniques and/or classifiers such as, in some examples, anomaly detection, clustering, and/or supervised and/or association. In one example, the AI neural networks may be developed and/or based on a bidirectional encoder representations for transformers (BERT) model by Google of Mountain View, CA.

The systems described herein may communicate with one or more foundational model systems (e.g., artificial intelligence neural networks). The foundational model system(s), in some examples, may be developed, trained, tuned, fine-tuned, and/or prompt engineered to evaluate data inputs such as information collected from the price data source(s) 106, the news and analyst data source(s) 108 and/or the economic indicator data source(s) 110 of FIG. 1, the economic indicator source(s) 206, the stock market price data source(s) 208, the investment vehicle news source(s) 214, the analyst ratings source(s) 216, the earnings reports source(s) 222, the historic performance snapshots 210, the historic sentiment snapshots 218, the historic economics snapshots 224, the anomalous movement snapshots 228, and/or the performance forecast snapshots 236 of FIG. 2, the member preferences 308 and/or the member portfolios 306 of FIG. 3, the performance forecast snapshots 604, the historic performance snapshots 606, the historic sentiment snapshots 608, and/or the historic economics snapshots 610 of FIG. 6, and/or historic member recommendations 704, the member portfolios 708, and/or the historic alert interactions 706 of FIG. 7. The foundational model systems, in some examples, may include or be based off of the generative pre-trained transformer (GPT) models available via the OpenAI platform by OpenAI of San Francisco, CA (e.g., GPT-3, GPT-3.5, and/or GPT-4) and/or the generative AI models available through Azure OpenAI or Vertex AI by Google of Mountain View, CA (e.g., PaLM 2).

Certain foundational models may be fine-tuned as AI models trained for performing particular tasks required by the systems described herein. Training material, for example, may be submitted to certain foundational models to adjust the training of the foundational model for performing types of analyses described herein.

Multiple foundational model systems may be applied by the systems and methods described herein depending on context. The context, for example, may include type(s) of data, type(s) of response output desired (e.g., at least one answer, at least one answer plus an explanation regarding the reasoning that lead to the answer(s), etc.). In another example, the context can include user-based context such as demographic information, entity information, and/or product information. In some embodiments, a single foundational model system may be dynamically adapted to different forms of analyses requested by the systems and methods described herein using prompt engineering.

While certain embodiments have been described, these embodiments have been presented by way of example only and are not intended to limit the scope of the present disclosure. Indeed, the novel methods, apparatuses and systems described herein can be embodied in a variety of other forms; further, various omissions, substitutions and/or changes in the form of the methods, apparatuses and systems described herein can be made without departing from the spirit of the present disclosure. The accompanying claims and their equivalents are intended to cover such forms or modifications as would fall within the scope and spirit of the present disclosure.

What is claimed is:

1. A system for tracking investment vehicles for anomalous behavior, the system comprising:
at least one non-transitory computer-readable medium configured to store
a plurality of asset performance snapshots, each asset performance snapshot comprising price data regarding a respective investment vehicle of a plurality of investment vehicles, and
a plurality of entity sentiment snapshots, each entity sentiment snapshot comprising sentiment data regarding a respective investment vehicle of the plurality of investment vehicles;
an anomalous movement analyzer configured to, for each respective investment vehicle of the plurality of investment vehicles,
access a series of asset performance snapshots of the plurality of asset performance snapshots corresponding to the respective investment vehicle, and a series of entity sentiment snapshots of the plurality of entity sentiment snapshots corresponding to the respective investment vehicle, and
analyze the price data of the series of asset performance snapshots and the sentiment data of the series of entity sentiment snapshots to identify anomalous movement involving one of an increasingly positive movement over time, an increasingly negative movement over time, a shift from negative movement to positive movement over time, or a shift from positive movement to negative movement over time;
an asset performance forecaster configured to, responsive to the anomalous movement analyzer identifying the anomalous movement in a portion of the plurality of investment vehicles, for each given investment vehicle of the portion,
provide the price data of the series of asset performance snapshots and the sentiment data of the series of entity sentiment snapshots of the given investment vehicle to an artificial neural network trained or fine-tuned in historic analysis of circumstances triggering anomalous behavior in a truth data set of investment assets to predict future performance of the respective investment vehicle,
receive, from the artificial neural network, a forecast trajectory in asset value of the given investment vehicle, and
store the forecast trajectory as respective performance prediction data of the given investment vehicle; and
a transaction recommender configured to access a set of user constraints for an investor comprising a risk tolerance and at least one of a timeframe or a total number of recommendations,
using the set of user constraints, filter the portion of the plurality of investment vehicles to determine a set of candidate investment vehicles, and
for each respective candidate investment vehicle of the set of candidate investment vehicles,
identify, based at least in part on the forecast trajectory and a portfolio of the investor, a recommended transaction comprising a trade type, and
prepare recommendation information for presentation to the investor, wherein preparing the recommendation information comprises
prompting a foundational model with a template and a structured facts object, the structured facts object comprising
the respective candidate investment vehicle, the trade type, one or more sentiment characteristics derived from the series of entity sentiment snapshots of the respective candidate investment vehicle, and one or more price characteristics derived from the series of asset performance snapshots of the respective candidate investment vehicle,
wherein the foundational model is prompted to return a human-readable analysis detailing reasoning behind recommending the respective candidate investment vehicle, wherein
the human-readable analysis is arranged according to a structure of the template.

2. The system of claim 1, further comprising an asset performance analyzer configured to, on at least a daily basis and for each respective investment vehicle of the plurality of investment vehicles:
capture, via a network from one or more data sources, one or more price values for the respective investment vehicle; and
store, as a respective snapshot of the plurality of asset performance snapshots, price data based on the one or more price values.

3. The system of claim 1, further comprising an entity sentiment analyzer configured to, on a periodic basis and for each respective investment vehicle of the plurality of investment vehicles,
collect, via a network from one or more news sources, a set of publications, each publication related to the respective investment vehicle or a respective entity associated with the respective investment vehicle;
analyze the set of publications to derive sentiment data regarding the respective investment vehicle; and
store, as a respective entity sentiment snapshot of the plurality of entity sentiment snapshots, the sentiment data.

4. The system of claim 3, wherein analyzing the set of publications comprises providing, to a foundational model, one or more prompts configured to direct the foundational model to derive, from the set of publications, a direction of sentiment captured in the set of publications.

5. The system of claim 1, further comprising an entity performance analyzer configured to, for each respective investment vehicle of the plurality of investment vehicles,
collect economic data regarding the respective entity associated with the respective investment vehicle,
analyze the economic data to determine a plurality of performance metrics, and
store the plurality of performance metrics as a respective entity economic snapshot of a plurality of entity economic snapshots of the at least one non-transitory computer-readable medium;
wherein to predict the future performance of the respective investment vehicle further comprises providing the plurality of performance metrics of the respective entity economic snapshot to the artificial neural network.

6. The system of claim 1, wherein analyzing the price data of the series of asset performance snapshots and the sentiment data of the series of entity sentiment snapshots to identify anomalous movement comprises performing sequence classification analysis of the price data of the series of asset performance snapshots and the sentiment data of the series of entity sentiment snapshots to identify behavior anomalous in view of at least one of a set of peers, an industry, or an asset class.

7. The system of claim 1, wherein analyzing the price data of the series of asset performance snapshots to identify anomalous movement comprises calculating at least one of a moving average convergence/divergence indicator, a relative strength index (RSI), or Bollinger Bands.

8. The system of claim 1, wherein the recommended transaction further comprises at least one of a trade size or a timeframe for performing the trade type.

9. The system of claim 8, wherein the transaction recommender is further configured to calculate a rebalancing shift of the portfolio to adjust a set of current weights of the portfolio to meet a set of target weights, wherein the trade size is determined based at least in part on the rebalancing shift.

10. The system of claim 1, further comprising a user interface manager configured to cause, via a graphical user interface presented on a computing device of the investor, presentation of the recommendation information.

11. The system of claim 10, wherein the user interface manager is configured to receive, via the graphical user interface, a transaction confirmation and cause placement, via an investment platform, of the recommended transaction.

12. A method tracking investment vehicles for automatically developing recommendations for building an investment portfolio, the method comprising:
capturing, by processing circuitry, a plurality of asset performance snapshots, each asset performance snapshot comprising price data regarding a respective investment vehicle of a plurality of investment vehicles;
capturing, by the processing circuitry, a plurality of entity sentiment snapshots, each entity sentiment snapshot comprising sentiment data regarding a respective investment vehicle of the plurality of investment vehicles;
for each respective investment vehicle of the plurality of investment vehicles,
accessing a series of asset performance snapshots of the plurality of asset performance snapshots corresponding to the respective investment vehicle and a series of entity sentiment snapshots of the plurality of entity sentiment snapshots corresponding to the respective investment vehicle, and
analyzing the price data of the series of asset performance snapshots and the sentiment data of the series of entity sentiment snapshots to identify anomalous movement involving one of an increasingly positive movement over time, an increasingly negative movement over time, a shift from negative movement to positive movement over time, or a shift from positive movement to negative movement over time;
responsive to the anomalous movement being identified in a portion of the plurality of investment vehicles, for each given investment vehicle of the portion,
providing, by the processing circuitry, the price data of the series of asset performance snapshots and the sentiment data of the series of entity sentiment snapshots of the given investment vehicle to an artificial neural network trained or fine-tuned in historic analysis of circumstances triggering anomalous behavior in a truth data set of investment assets to predict future performance of the respective investment vehicle,
receiving, from the artificial neural network, a forecast trajectory in asset value of the given investment vehicle, and
storing, by the processing circuitry, the forecast trajectory as respective performance prediction data of the given investment vehicle;
accessing, by the processing circuitry, a set of user constraints for an investor comprising a risk tolerance and at least one of a timeframe or a total number of recommendations;
using the set of user constraints, filtering, by the processing circuitry, the portion of the plurality of investment vehicles to determine a set of candidate investment vehicles; and
for each respective candidate investment vehicle of the set of candidate investment vehicles,
identifying, based at least in part on the forecast trajectory and a portfolio of the investor, a recommended transaction comprising a trade type, and
preparing recommendation information for presentation to the investor, wherein preparing the recommendation information comprises
prompting a foundational model with a template and a structured facts object, the structured facts object comprising
the respective candidate investment vehicle, the trade type, one or more sentiment characteristics derived from the series of entity sentiment snapshots of the respective candidate investment vehicle, and one or more price characteristics derived from the series of asset performance snapshots of the respective candidate investment vehicle,
wherein the foundational model is prompted to return a human-readable analysis detailing reasoning behind recommending the respective candidate investment vehicle, wherein
the human-readable analysis is arranged according to a structure of the template.

13. The method of claim 12, wherein capturing the plurality of entity sentiment snapshots comprises, for each respective investment vehicle of the plurality of investment vehicles:
collecting, via a network from one or more news sources, a set of publications, each publication related to the respective investment vehicle or a respective entity associated with the respective investment vehicle;
analyzing the set of publications to derive sentiment data regarding the respective investment vehicle; and
storing, as a respective entity sentiment snapshot of the plurality of entity sentiment snapshots, the sentiment data.

14. The method of claim 12, further comprising, for each respective investment vehicle of the plurality of investment vehicles:
collecting, by the processing circuitry, economic data regarding the respective entity associated with the respective investment vehicle;
analyzing, by the processing circuitry, the economic data to determine a plurality of performance metrics; and
storing, by the processing circuitry, the plurality of performance metrics as a respective entity economic snapshot of a plurality of entity economic snapshots;
wherein to predict the future performance of the respective investment vehicle further comprises providing the plurality of performance metrics of the respective entity economic snapshot to the artificial neural network.

15. The method of claim 12, wherein analyzing the price data of the series of asset performance snapshots and the sentiment data of the series of entity sentiment snapshots to identify anomalous movement comprises performing sequence classification analysis of the price data of the series of asset performance snapshots and the sentiment data of the series of entity sentiment snapshots to identify behavior anomalous in view of at least one of a set of peers, an industry, or an asset class.

16. The method of claim 12, wherein analyzing the price data of the series of asset performance snapshots to identify anomalous movement comprises calculating at least one of a moving average convergence/divergence indicator, a relative strength index (RSI), or Bollinger Bands.

17. The method of claim 12, wherein the recommended transaction further comprises at least one of a trade size or a timeframe for performing the trade type.

18. The method of claim 17, further comprising:
calculating, by the processing circuitry, a rebalancing shift of the portfolio to adjust a set of current weights of the portfolio to meet a set of target weights;
wherein the trade size is determined based at least in part on the rebalancing shift.

19. The method of claim 12, further comprising causing, by the processing circuitry via a graphical user interface presented on a computing device of the investor, presentation of the recommendation information.

20. The method of claim 19, further comprising:
receiving, via the graphical user interface, a transaction confirmation; and
causing placement, by the processing circuitry via an investment platform, of the recommended transaction.
